(19) United States
(12) Patent Application Publication
(10) Pub. No.: US 2025/0283565 A1
(43) Pub. Date: Sep. 11, 2025

(54) FIRST JOINT AND PIPE JOINT

(71) Applicant: NIDEC CORPORATION, Kyoto (JP)

(72) Inventors: Naoyuki TAKASHIMA, Kyoto (JP); Takehito TAMAOKA, Kyoto (JP); Toshihiko TOKESHI, Kyoto (JP)

(21) Appl. No.: 19/218,927

(22) Filed: May 27, 2025

Related U.S. Application Data
(63) Continuation of application No. PCT/JP2023/042758, filed on Nov. 29, 2023.

(30) Foreign Application Priority Data
Nov. 30, 2022 (JP) 2022-192116
Nov. 28, 2023 (JP) 2023-200413

(51) Int. Cl. F16L 37/084; F16L 37/46

(52) U.S. Cl. CPC F16L 37/084; F16L 37/46

(57) ABSTRACT

A first joint has a central axis and extends in an axial direction along the central axis. The first joint includes a first joint body, an axially facing portion, an actuation portion, and a mounting portion. The first joint body is coupled to the second joint along the central axis. The axially facing portion axially opposes a protruding portion protruding from an outer peripheral surface of the second joint, from a front end side in an axial direction of the first joint body. The actuation portion is connected to the axially facing portion and is actuatable along an axis intersecting direction intersecting the central axis. The mounting portion includes an actuation portion restricting portion restricting movement of the actuation portion in a state where the axially facing portion and the protruding portion oppose each other.

### CROSS REFERENCE TO RELATED APPLICATIONS

This is a Continuation of PCT Application No. PCT/JP2023/042758, filed on Nov. 29, 2023, with priority being claimed from Japanese Applications No. 2022-192116, filed Nov. 30, 2022, and 2023-200413, filed Nov. 28, 2023, the entire disclosures of which are hereby incorporated herein by reference.

### BACKGROUND OF THE INVENTION

### 1. Field of the Invention

The present invention relates to first joints and pipe joints.

### 2. Background

In a conventional joint device, a user manually operates the actuation portion to quickly connect and disconnect the joint body with a portion of the fluid transport device. The actuation portion reciprocates with respect to the outer surface of the joint body by the action of the biasing member (for example, US 2005/0001425 A).

Specifically, an insert assembly is inserted into the joint body. In this case, the tapered surface of the insert assembly locks the insert assembly with respect to the joint body. Further, the lock is released by pushing down the actuation portion, and the insert assembly can be detached and removed from the joint body.

### SUMMARY

However, in the conventional joint device, for example, when the actuation portion comes into contact with another member, the lock of the insert assembly may be released due to malfunction of the actuation portion.

Example embodiments of the present disclosure have been made in view of the above problem, and provide first joints and pipe joints each capable of reducing or preventing malfunction of an actuation portion.

A first joint according to an example embodiment of the present disclosure includes a central axis and extends axially along the central axis. The first joint includes a first joint body, an axially facing portion, an actuation portion, and a mounting portion. The first joint body is coupled to the second joint along the central axis. In a state where the first joint body is coupled to the second joint, the axially facing portion axially opposes a protruding portion protruding from an outer peripheral surface of the second joint, from a front end side in an axial direction of the first joint body. The actuation portion is connected to the axially facing portion and is actuatable along an axis intersecting direction intersecting the central axis to switch between a facing state and a non-facing state of the axially facing portion and the protruding portion in the axial direction. The mounting portion is mounted on the outer peripheral surface of the first joint body. The mounting portion includes an actuation portion restricting portion to restrict movement of the actuation portion in a state where the axially facing portion and the protruding portion face each other.

An example embodiment of a first joint of the present disclosure has a central axis and extends axially along the central axis. The first joint includes a first joint body, an axially facing portion, an actuation portion, and a mounting portion. The first joint body is coupled to the second joint along the central axis. In a state where the first joint body is coupled to the second joint, the axially facing portion axially opposes a protruding portion protruding from the outer peripheral surface of the second joint, from the front end side in the axial direction of the first joint body. The actuation portion is connected to the axially facing portion and is actuatable along the axis intersecting direction intersecting the central axis to switch between a facing state and a non-facing state of the axially facing portion and the protruding portion in the axial direction. The mounting portion is mounted on the outer peripheral surface of the first joint body. The mounting portion includes an intersecting direction facing portion. In a state where the axially facing portion and the protruding portion oppose each other, the intersecting direction facing portion opposes the actuation portion in the axis intersecting direction between the first joint body and the actuation portion.

An example embodiment of a pipe joint of the present disclosure includes the first joint and the second joint described above.

According to example embodiments of the present disclosure, malfunction of the actuation portion can be reduced or prevented.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view illustrating a second joint according to a first example embodiment of the present disclosure.

FIG. 2 is a cross-sectional view taken along line II-II of FIG. 1.

FIG. 3 is a perspective view illustrating a first joint according to the first example embodiment of the present disclosure

FIG. 4 is an exploded perspective view illustrating the first joint according to the first example embodiment of the present disclosure.

FIG. 5 is a cross-sectional view taken along line V-V of FIG. 3.

FIG. 6 is a cross-sectional view illustrating a state in which an actuation portion of the first joint according to the first example embodiment of the present disclosure is located at an open position.

FIG. 7 is a cross-sectional view illustrating a state in which the first joint and the second joint according to the first example embodiment of the present disclosure are connected.

FIG. 8 is a plan view illustrating the first joint according to the first example embodiment of the present disclosure.

FIG. 9 is a cross-sectional view taken along line IX-IX of FIG. 8.

FIG. 10 is a plan view illustrating another state of the first joint according to the first example embodiment of the present disclosure.

FIG. 11 is a cross-sectional view taken along line XI-XI of FIG. 10.

FIG. 12 is a plan view illustrating a mounting portion according to the first example embodiment of the present disclosure.

FIG. 13 is a perspective view illustrating the mounting portion according to the first example embodiment of the present disclosure.

FIG. 14 is a rear view illustrating the mounting portion according to the first example embodiment of the present disclosure.

FIG. 15 is a front view illustrating the first joint according to the first example embodiment of the present disclosure.

FIG. 16 is a perspective view illustrating a first joint according to a modification of the first example embodiment of the present disclosure.

FIG. 17A is a diagram illustrating a first position of a mounting portion according to the present modification.

FIG. 17B is a diagram illustrating a second position of the mounting portion according to the present modification.

FIG. 18 is a plan view illustrating the first joint when the mounting portion according to the present modification is located at the first position.

FIG. 19 is a plan view illustrating the first joint when the mounting portion according to the present modification is located at the second position.

FIG. 20 is a cross-sectional view illustrating a first joint according to a second example embodiment of the present disclosure.

FIG. 21 is a cross-sectional view illustrating the first joint according to the second example embodiment of the present disclosure.

FIG. 22 is a cross-sectional view illustrating the first joint according to the second example embodiment of the present disclosure.

FIG. 23 is a cross-sectional view illustrating a first joint according to a third example embodiment of the present disclosure.

FIG. 24 is a cross-sectional view illustrating the first joint according to the third example embodiment of the present disclosure.

FIG. 25 is a cross-sectional view illustrating a first joint according to a fourth example embodiment of the present disclosure.

FIG. 26 is a cross-sectional view illustrating the first joint according to the fourth example embodiment of the present disclosure.

FIG. 27 is a cross-sectional view illustrating the first joint according to the fourth example embodiment of the present disclosure.

### DETAILED DESCRIPTION

Hereinafter, example embodiments of the present disclosure will be described with reference to the drawings. Note that in the drawings, the same or corresponding parts will be denoted by the same reference symbols and description of such parts will not be repeated. In the drawings, the X, Y, and Z axes of the three-dimensional orthogonal coordinate system are described as appropriate for ease of understanding.

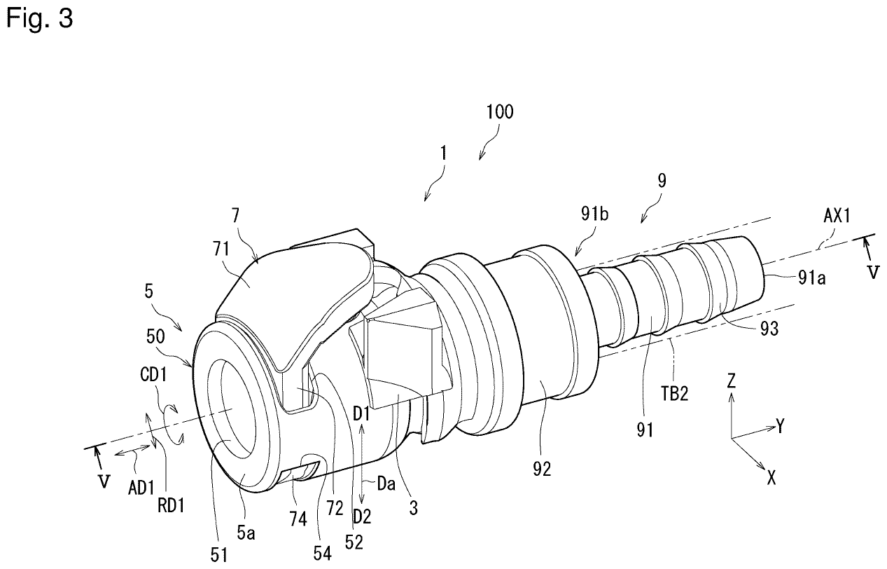

In the present description, a direction parallel to a central axis AX1 (for example, FIG. 3) of a first joint is referred to as an “axial direction AD1”. Further, a direction orthogonal to the central axis AX1 is referred to as a “radial direction RD1”. The “radial direction RD1” may be any direction as long as the direction is a direction orthogonal to the central axis AX1, and is not particularly limited. Further, a direction along an arc around the central axis AX1 is referred to as a “circumferential direction CD1”.

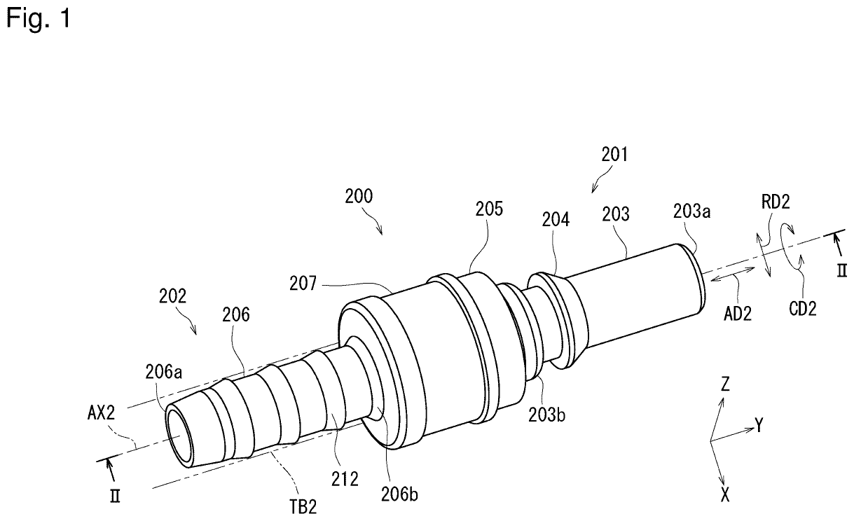

Further, a direction parallel to a central axis AX2 (for example, FIG. 1) of a second joint is referred to as an “axial direction AD2”. Further, a direction orthogonal to the central axis AX2 is referred to as a “radial direction RD2”. The “radial direction RD2” may be any direction as long as the direction is a direction orthogonal to the central axis AX2, and is not particularly limited. Further, a direction along an arc around the central axis AX2 is referred to as a “circumferential direction CD2”.

Further, in the present description, a “parallel direction” includes a substantially parallel direction, and an “orthogonal direction” includes a substantially orthogonal direction. Furthermore, in the present description, an “annular shape”, a “cylindrical shape”, an “annular shape”, a “tubular shape”, a “circular shape”, and a “wavy shape” do not represent a shape in a strict sense, and include, for example, a shape that can realize a function of the first joint or the second joint in the present disclosure.

### First Example Embodiment

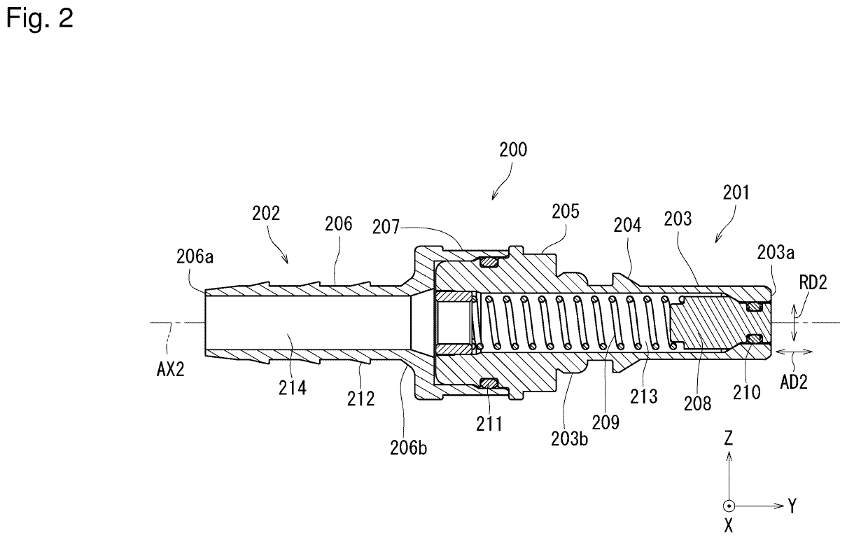

A first joint 100 and a second joint 200 according to a first example embodiment of the present disclosure will be described with reference to FIGS. 1 to 15. First, the second joint 200 will be described with reference to FIGS. 1 and 2.

FIG. 1 is a perspective view illustrating the second joint 200 according to the example embodiment of the present disclosure. As illustrated in FIG. 1, the second joint 200 has the central axis AX2. The second joint 200 extends in the axial direction AD2 along the central axis AX2. The second joint 200 is a male joint. In the present example embodiment, the “front” of the second joint 200 indicates a side to be inserted into the first joint 100 (FIG. 3). “Rear” of the second joint 200 indicates a side to be inserted into a tube TB2.

The second joint 200 has a protruding portion 204. Specifically, the second joint 200 includes a plug part 201 and an insertion part 202. The plug part 201 and the insertion part 202 are coupled in the axial direction AD2. The plug part 201 includes a plug body 203, the protruding portion 204, and a coupling body 205.

The plug body 203 has a cylindrical shape. The protruding portion 204 protrudes from an outer peripheral surface of the second joint 200. Specifically, the protruding portion 204 protrudes toward the outer side in the radial direction RD2 from the outer peripheral surface of the plug body 203. The protruding portion 204 extends along the circumferential direction CD2. The protruding portion 204 has an annular shape. The protruding portion 204 extends with respect to the central axis AX2 from a front end 203a toward a rear end 206a of the second joint 200 in the axial direction AD2. That is, the diameter of the protruding portion 204 increases from the front end 203a toward the rear end 206a of the second joint 200. The protruding portion 204 is located on a rear end portion 203b side in the axial direction AD2 of the plug body 203.

The coupling body 205 is connected to the rear end portion 203b of the plug body 203. The coupling body 205 and the plug body 203 are constituted as a single member (integrally molded product). The coupling body 205 has a cylindrical shape.

The insertion part 202 is inserted into the tube TB2. Specifically, the insertion part 202 includes an insertion body 206, a coupling body 207, and a plurality of protrusions 212. The insertion body 206 is inserted into the tube TB2. The insertion body 206 has a cylindrical shape. The protrusion 212 protrudes toward the outer side in the radial direction RD2 from an outer peripheral surface of the insertion body 206. The protrusion 212 has an annular shape. The diameter of the protrusion 212 increases from the rear end 206a toward the front end 203a in the axial direction AD2 of the second joint 200.

The coupling body 207 is connected to the rear end portion 206b in the axial direction AD2 of the insertion body 206. The coupling body 207 and the insertion body 206 are constituted as a single member (integrally molded product). The coupling body 207 has a cylindrical shape.

The coupling body 205 of the plug part 201 is fitted into the coupling body 207 of the insertion part 202. As a result, the plug part 201 and the insertion part 202 are coupled.

FIG. 2 is a cross-sectional view taken along line II-II of FIG. 1. FIG. 2 illustrates a state in which the second joint 200 is separated from the first joint 100. That is, a state in which the second joint 200 is not coupled to the first joint 100 is illustrated. As illustrated in FIG. 2, the plug part 201 further includes a plug valve 208, an elastic portion 209, a seal member 210, a seal member 211, and a flow path 213. The insertion part 202 further includes a flow path 214. The flow paths 213 and 214 extend along the axial direction AD2. The front end in the axial direction AD2 of the flow path 214 is connected to the rear end in the axial direction AD2 of the flow path 213. That is, the flow path 213 and the flow path 214 are connected.

The plug valve 208 is arranged in the flow path 213 on the front end 203a side of the plug body 203. The plug valve 208 is pushed from the rear end portion 203b side to the front end 203a side of the plug body 203 by the elastic portion 209. The plug valve 208 closes the flow path 213 on the front end 203a side of the plug body 203. The seal member 210 is attached to the outer peripheral surface of the plug valve 208. The seal member 210 is an elastic body and has an annular shape. Specifically, the seal member 210 seals the flow path 213 on the front end 203a side of the plug body 203.

The elastic portion 209 is arranged in the flow path 213. The elastic portion 209 has elasticity. The elastic portion 209 is, for example, a compression coil spring. The seal member 211 is attached to the outer peripheral surface of the coupling body 205. The seal member 211 is an elastic body and has an annular shape. The seal member 211 seals between the outer peripheral surface of the coupling body 205 and the inner peripheral surface of the coupling body 207.

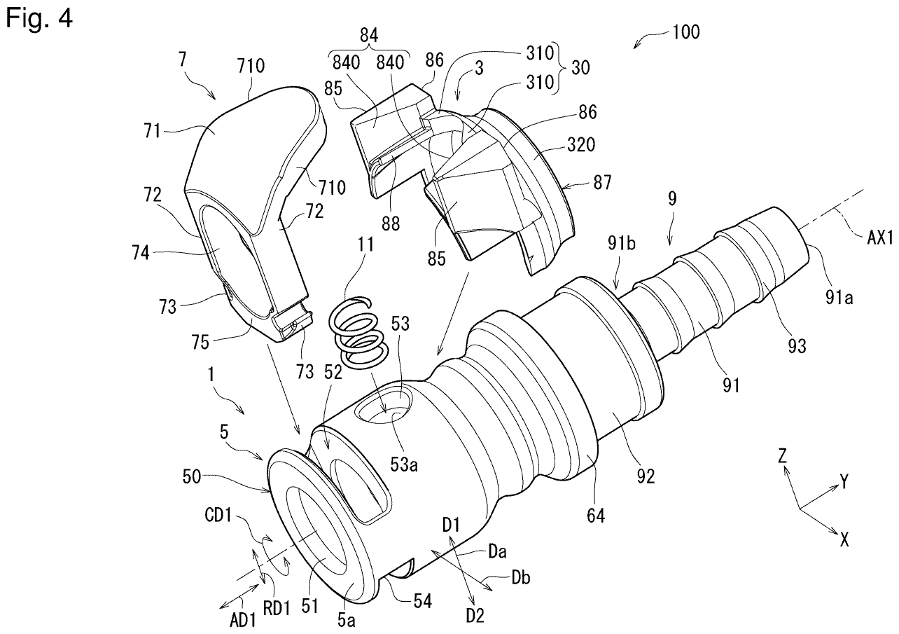

Next, the first joint 100 will be described with reference to FIGS. 3 to 6. FIG. 3 is a perspective view illustrating the first joint 100 according to the present example embodiment. FIG. 4 is an exploded perspective view illustrating the first joint 100.

As illustrated in FIGS. 3 and 4, the first joint 100 has the central axis AX1. The first joint 100 extends in the axial direction AD1 along the central axis AX1. The first joint 100 is a female joint. The first joint 100 is coupled to the second joint 200 (FIG. 1) along the central axis AX1. In the present example embodiment, the “front” of the first joint 100 indicates a side on which the second joint 200 is inserted. The “rear” of the first joint 100 indicates a side to be inserted into a tube TB1.

The first joint 100 includes a first joint body 1, a mounting portion 3, an actuation portion 71, and an elastic portion 11. Specifically, the first joint 100 includes an actuation portion 7. The actuation portion 7 has the actuation portion 71. The first joint body 1 extends along the axial direction AD1. The first joint body 1 is coupled to the second joint 200 (FIG. 1) along the central axis AX1. The mounting portion 3 is mounted on the outer peripheral surface of the first joint body 1. Details of the mounting portion 3 will be described later. The actuation portion 7 is operated by an operator to switch the coupling state between the first joint body 1 and the second joint 200 between a locked state and an unlocked state. The locked state indicates a state in which coupling between the first joint body 1 and the second joint 200 cannot be released. The unlocked state indicates a state in which coupling between the first joint body 1 and the second joint 200 can be released. The elastic portion 11 supports the actuation portion 7. As an example, the actuation portion 7 (actuation portion 71) and the elastic portion 11 constitute a push button.

Specifically, the first joint body 1 includes a socket part 5 and an insertion part 9. The socket part 5 and the insertion part 9 are connected in the axial direction AD1. The plug part 201 (FIG. 1) of the second joint 200 is inserted into the socket part 5. The mounting portion 3 is mounted on the outer peripheral surface of the socket part 5.

The socket part 5 has a socket body 50. The plug body 203 (FIG. 1) of the second joint 200 is inserted into the socket body 50. The socket body 50 has a cylindrical shape.

The socket body 50 has an opening 51. The opening 51 has a circular shape. The opening 51 is located on a front end 5a side of the socket body 50. The opening 51 is open in the axial direction AD1.

With continued reference to FIGS. 3 and 4, the configuration related to the actuation portion 7 and the actuation portion 7 will be described. The socket body 50 further includes a through hole 52 and a recess 53. The through hole 52 penetrates the socket body 50 in an axis intersecting direction Da. The axis intersecting direction Da intersects the central axis AX1. In the present example embodiment, the axis intersecting direction Da is orthogonal to the central axis AX1. The actuation portion 7 is disposed in the through hole 52 along the axis intersecting direction Da. The recess 53 is recessed in the axis intersecting direction Da with respect to the outer peripheral surface of socket body 50. The elastic portion 11 is disposed in the recess 53 along the axis intersecting direction Da. The elastic portion 11 has elasticity. The elastic portion 11 is, for example, a compression coil spring. The elastic portion 11 extends and contracts in the axis intersecting direction Da. The elastic portion 11 is disposed between the actuation portion 71 of the actuation portion 7 and the bottom surface 53a of the recess 53. The elastic portion 11 supports the actuation portion 71.

The socket body 50 further includes a pair of contact portions 54. In FIGS. 3 and 4, only one contact portion 54 appears. The actuation portion 7 further includes a pair of connecting portions 72, a pair of stoppers 73, an opening 74, and an axially facing portion 75.

One side D1 and the other side D2 of the axis intersecting direction Da will be defined. One side D1 indicates a direction (first direction) from the axially facing portion 75 toward the actuation portion 71 in a state where the actuation portion 7 is disposed in the through hole 52. The other side D2 indicates a direction (second direction) from the actuation portion 71 toward the axially facing portion 75 in a state where the actuation portion 7 is disposed in the through hole 52.

The pair of connecting portions 72 extends along the axis intersecting direction Da. The pair of connecting portions 72 connects the actuation portion 71 and the axially facing portion 75. That is, the actuation portion 71 is connected to the axially facing portion 75 by the pair of connecting portions 72. The connecting portion 72 has a columnar shape. The actuation portion 71, the pair of connecting portions 72, and the axially facing portion 75 define the opening 74. The opening 74 opens in the axial direction AD1.

The pair of stoppers 73 is disposed at both ends of the axially facing portion 75 in a direction Db. The direction Db indicates a direction orthogonal to the axis intersecting direction Da and the axial direction AD1. As illustrated in FIG. 3, in a state where the actuation portion 7 is disposed in the through hole 52, the pair of stoppers 73 faces the pair of contact portions 54 in the axis intersecting direction Da. Specifically, in a state where the stopper 73 and the contact portion 54 face each other, the contact portion 54 is located on the one side D1 of the stopper 73, and the stopper 73 is located on the other side D2 of the contact portion 54. The pair of contact portions 54 face each other in the direction Db. The through hole 52 is provided between the pair of contact portions 54.

In a state where the actuation portion 7 is disposed in the through hole 52, the elastic portion 11 pushes the actuation portion 71 toward the one side D1 in the axis intersecting direction Da. In this case, the stopper 73 of the actuation portion 7 comes into contact with the contact portion 54 in the axis intersecting direction Da. Therefore, the stopper 73 prevents the actuation portion 7 from coming out of the through hole 52 toward the one side D1 in the axis intersecting direction Da. That is, actuation portion 7 is held by the socket body 50 while being disposed in through hole 52. The position of the actuation portion 7 when the stopper 73 is in contact with the contact portion 54 may be referred to as an “initial position”.

On the other hand, when a force is applied to the actuation portion 7 toward the other side D2 in the axis intersecting direction Da in a state where the actuation portion 7 is disposed in the through hole 52, the actuation portion 7 moves from the initial position toward the other side D2 in the axis intersecting direction Da against the elastic force of the elastic portion 11. When the force on the actuation portion 7 is released, due to the elastic force of the elastic portion 11, the actuation portion 7 moves toward the one side D1 in the axis intersecting direction Da until the stopper 73 comes into contact with the contact portion 54. That is, the actuation portion 7 returns to the initial position.

Subsequently, referring to FIGS. 3 and 4, the insertion part 9 is inserted into the tube TB1. Specifically, the insertion part 9 includes an insertion body 91, a coupling body 92, and a plurality of protrusions 93. The insertion body 91 is inserted into the tube TB1. The insertion body 91 has a cylindrical shape. The protrusion 93 protrudes outward in the radial direction RD1 from an outer peripheral surface of the insertion body 91. The protrusion 93 has an annular shape. The diameter of the protrusion 93 increases from the rear end 91a toward the front end 5a in the axial direction AD1 of the first joint 100.

The coupling body 92 is coupled to the socket part 5. The coupling body 92 is connected to the rear end portion 91b in the axial direction AD1 of the insertion body 91. The coupling body 92 and the insertion body 91 are constituted as a single member (integrally molded product). The coupling body 92 has a cylindrical shape.

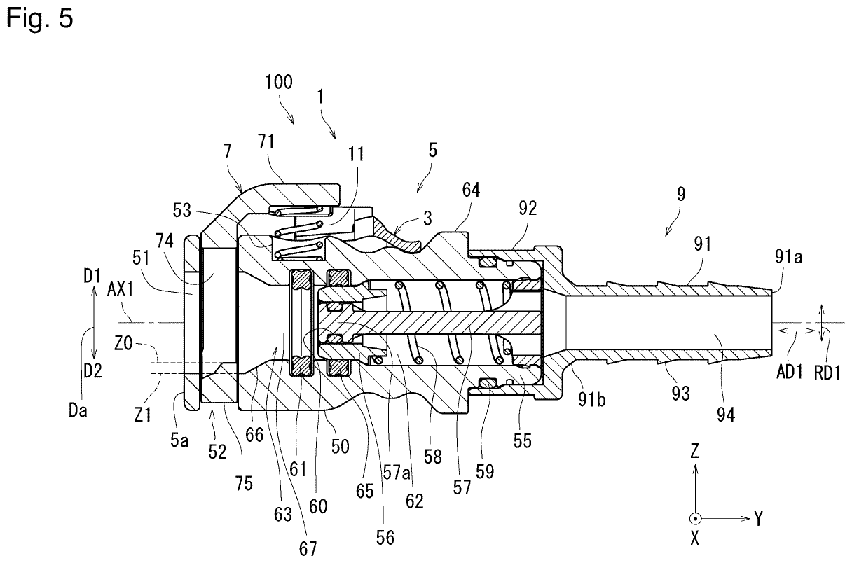

Next, the internal structure of the first joint 100 will be described with reference to FIG. 5. FIG. 5 is a cross-sectional view taken along line V-V of FIG. 3. FIG. 5 illustrates a state in which the first joint 100 is separated from the second joint 200. That is, a state in which the first joint 100 is not coupled to the second joint 200 is illustrated.

As illustrated in FIG. 5, the socket part 5 further includes a coupling body 55, a socket valve 56, a stem portion 57, an elastic portion 58, seal members 59, 60, 61, and 65, a flow path 62, and a plug arrangement portion 63. In the plug arrangement portion 63, the plug body 203 (FIG. 1) is arranged. Specifically, the plug arrangement portion 63 has a plug arrangement space 67. Then, the plug body 203 is arranged in the plug arrangement space 67. Further, the plug arrangement portion 63 has a protrusion arrangement portion 66. The protruding portion 204 (FIG. 1) of the plug body 203 is arranged in the protrusion arrangement portion 66. The insertion part 9 further includes a flow path 94. The first joint body 1 further includes an overhanging portion 64. Specifically, the socket body 50 of socket part 5 has the overhanging portion 64. Details of the overhanging portion 64 will be described later.

The flow paths 94 and 62 and the plug arrangement space 67 extend along the axial direction AD1. A front end in the axial direction AD1 of the flow path 94 is connected to the rear end in the axial direction AD1 of the flow path 62. That is, the flow path 94 and the flow path 62 are connected to each other. Further, the front end in the axial direction AD1 of the flow path 62 is connected to the rear end in the axial direction AD1 of the plug arrangement space 67. That is, the flow path 62 and the plug arrangement space 67 are connected to each other. The front end in the axial direction AD1 of the plug arrangement space 67 is connected to the opening 74. That is, the plug arrangement space 67 is connected to the opening 74. Further, the opening 74 is connected to the opening 51 in the axial direction AD1.

The coupling body 55 is connected to the overhanging portion 64 of the socket body 50. The overhanging portion 64 is positioned at a rear end portion in the axial direction AD1 of the socket body 50. The coupling body 55 and the socket body 50 are constituted as a single member (integrally molded product). The coupling body 55 has a cylindrical shape.

The coupling body 55 of the socket part 5 is fitted to the coupling body 92 of the insertion part 9. As a result, the socket part 5 and the insertion part 9 are coupled.

The socket valve 56 has a cylindrical shape. The socket valve 56 is arranged in a rear end portion of the plug arrangement space 67. The socket valve 56 is pushed by the elastic portion 58 from the overhanging portion 64 side to the front end 5a side of the socket body 50. The socket valve 56 closes the rear end portion of the plug arrangement space 67. The seal member 65 is disposed in the plug arrangement space 67. The seal member 65 is an elastic body and has an annular shape. When the seal member 65 comes into contact with the outer peripheral surface of the socket valve 56, the rear end portion of the plug arrangement space 67 is sealed.

The stem portion 57 extends along the axial direction AD1. A front end portion 57a in the axial direction AD1 of the stem portion 57 is arranged in the rear end portion of the plug arrangement space 67. In the example of FIG. 5, the front end portion 57a is arranged inside the socket valve 56. The seal member 60 is attached to the outer peripheral surface of the front end portion 57a. The seal member 60 is an elastic body and has an annular shape. Specifically, the seal member 60 seals a space between the outer peripheral surface of the stem portion 57 and the inner peripheral surface of the socket valve 56. Further, the seal member 61 is arranged in the plug arrangement space 67. The seal member 61 is disposed closer to the front end 5a of the socket body 50 than the seal member 65.

The elastic portion 58 is arranged in the flow path 62. The elastic portion 58 has elasticity. The elastic portion 58 is, for example, a compression coil spring. The seal member 59 is attached to the outer peripheral surface of the coupling body 55. The seal member 59 is an elastic body and has an annular shape. The seal member 59 seals a space between the outer peripheral surface of the coupling body 55 and the inner peripheral surface of the coupling body 92.

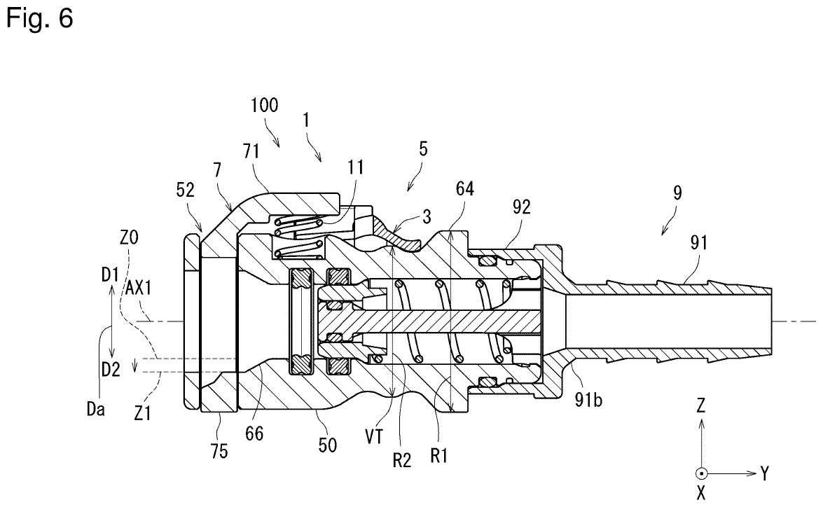

Next, the actuation portion 7 will be described with reference to FIGS. 5 and 6. FIG. 5 shows the actuation portion 7 when the axially facing portion 75 is located at the initial position Z0. As illustrated in FIG. 5, in a state where the actuation portion 7 (actuation portion 71) is pressed by the elastic portion 11 to the one side D1 of the axis intersecting direction Da and is stationary, the axially facing portion 75 is located at the initial position Z0. At the initial position Z0, the axially facing portion 75 faces the protrusion arrangement portion 66 in the axial direction AD1. That is, at the initial position Z0, the axially facing portion 75 faces the protrusion arrangement portion 66 in the axial direction AD1.

FIG. 6 illustrates the actuation portion 7 when the axially facing portion 75 is located at the open position Z1. As illustrated in FIG. 6, when an external force is applied to the actuation portion 7 (actuation portion 71) toward the other side D2 in the axis intersecting direction Da, the actuation portion 7 (actuation portion 71) is pressed against the elastic force of the elastic portion 11 toward the other side D2 in the axis intersecting direction Da and stands still. As a result, the axially facing portion 75 moves from the initial position Z0 to the open position Z1 and stands still. At the open position Z1, the axially facing portion 75 is located on the other side D2 in the axis intersecting direction Da with respect to the protrusion arrangement portion 66. Therefore, at the open position Z1, the axially facing portion 75 does not face the protrusion arrangement portion 66 in the axial direction AD1. As a result, the front side in the axial direction AD1 of the protrusion arrangement portion 66 is opened at the open position Z1. The “external force” is applied to the actuation portion 7 (actuation portion 71) by an operator, for example. For example, the operator presses the actuation portion 71 with a finger.

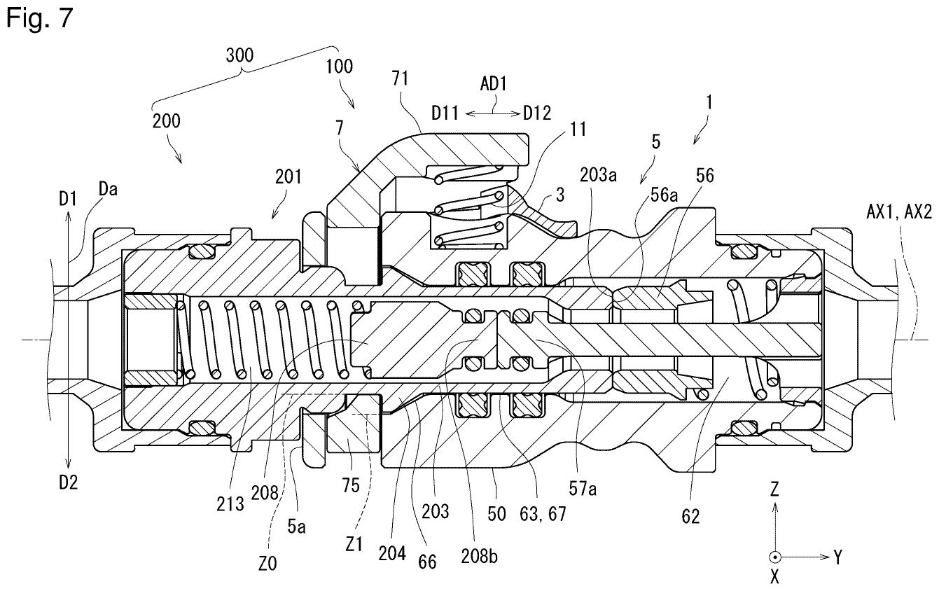

Next, a state in which the first joint 100 and the second joint 200 are coupled will be described with reference to FIG. 7. FIG. 7 is a cross-sectional view illustrating a state in which the first joint 100 and the second joint 200 are coupled. In a state where the first joint 100 and the second joint 200 are coupled to each other, the central axis AX1 of the first joint 100 and the central axis AX2 of the second joint 200 coincide with each other. Therefore, the axial direction AD1 and the axial direction AD2 coincide with each other, the radial direction RD1 and the radial direction RD2 coincide with each other, and the circumferential direction CD1 and the circumferential direction CD2 coincide with each other.

As illustrated in FIG. 7, the first joint 100 and the second joint 200 constitute a pipe joint 300. That is, the pipe joint 300 includes the first joint 100 and the second joint 200.

When the plug body 203 is inserted into the socket body 50, the front end 203a in the axial direction AD1 of the plug body 203 and a front end 56a in the axial direction AD1 of the socket valve 56 come into contact with each other. Therefore, the socket valve 56 moves from one side D11 toward the other side D12 in the axial direction AD1 by the plug body 203. At the same time, when the plug body 203 is inserted into the socket body 50, the front end portion 57a in the axial direction AD1 of the stem portion 57 and a front end portion 280b in the axial direction AD1 of the plug valve 208 come into contact with each other. Therefore, the plug valve 208 moves from the other side D12 to the one side D11 in the axial direction AD1. As a result, the flow path 213 of the plug part 201 and the flow path 62 of the socket part 5 are connected. Therefore, liquid flows between the first joint 100 and the second joint 200.

Subsequently, with reference to FIG. 7, a case where the coupling state between the first joint 100 and the second joint 200 is switched between the locked state and the unlocked state will be described. In a state where the first joint 100 and the second joint 200 are coupled, the plug body 203 is disposed in the plug arrangement portion 63 (plug arrangement space 67) of the socket body 50. In this case, the protruding portion 204 of the plug body 203 is disposed in the protrusion arrangement portion 66.

The actuation portion 7 is pressed to the one side D1 in the axis intersecting direction Da by the elastic portion 11. Therefore, the axially facing portion 75 of the actuation portion 7 is located at the initial position Z0. As a result, the protruding portion 204 and the axially facing portion 75 of the plug body 203 face each other in the axial direction AD1 and are in contact with each other. That is, at the initial position Z0, the axially facing portion 75 faces the protruding portion 204 protruding from the outer peripheral surface of the second joint 200 in the axial direction AD1 from the front end 5a side of the first joint body 1 in the axial direction AD1, in a state where the first joint body 1 is connected to the second joint 200. Therefore, the coupling state between the first joint 100 and the second joint 200 becomes the locked state.

On the other hand, when an external force is applied to the actuation portion 71 toward the other side D2 in the axis intersecting direction Da, the axially facing portion 75 moves from the initial position Z0 to the open position Z1. At the open position Z1, the axially facing portion 75 does not face the protruding portion 204 in the axial direction AD1. As a result, the front side in the axial direction AD1 of the protruding portion 204 is opened. Therefore, the coupled state between the first joint 100 and the second joint 200 becomes the unlocked state. That is, the coupled state between the first joint 100 and the second joint 200 is unlocked. Therefore, the second joint 200 can be separated from the first joint 100. The “external force” is applied to the actuation portion 7 (actuation portion 71) by an operator, for example. For example, the operator presses the actuation portion 71 with a finger.

As described above with reference to FIG. 7, the actuation portion 71 is actuated along the axis intersecting direction Da to switch between the facing state and the non-facing state of the axially facing portion 75 and the protruding portion 204 in the axial direction AD1.

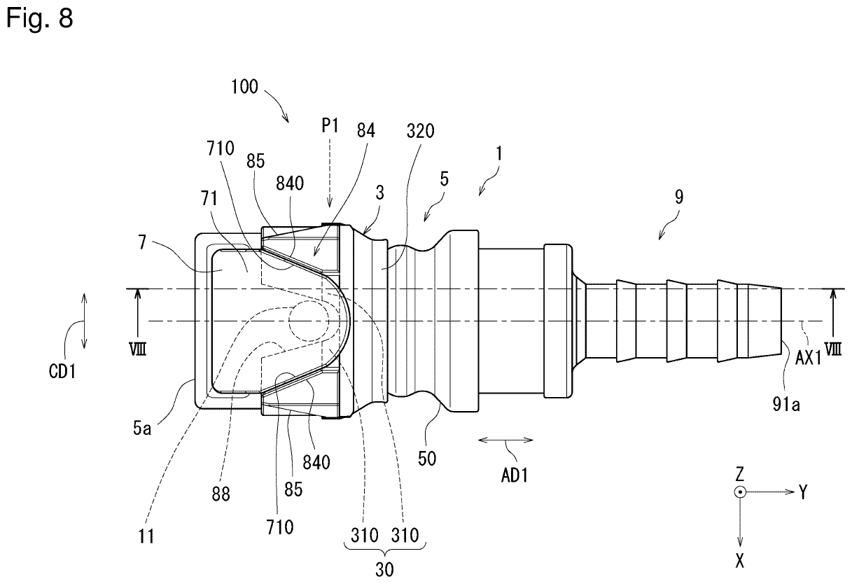

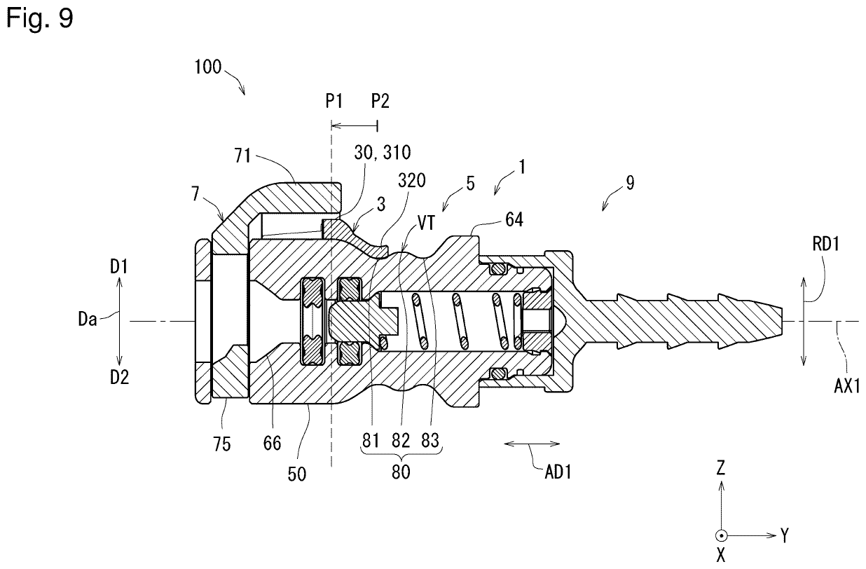

Next, the actuation portion 7 will be described with reference to FIGS. 4, 8, and 9. FIG. 8 is a plan view illustrating the first joint 100. FIG. 9 is a cross-sectional view taken along line IX-IX of FIG. 8.

As illustrated in FIGS. 4 and 8, the mounting portion 3 has an intersecting direction facing portion 30. In the present example embodiment, the intersecting direction facing portion 30 has two opposite pieces 310. The two opposite pieces 310 face each other in the direction Db (FIG. 4).

As illustrated in FIG. 9, in a state where the axially facing portion 75 and the protruding portion 204 face each other (FIG. 7), the intersecting direction facing portion 30 faces the actuation portion 71 in the axis intersecting direction Da between the first joint body 1 and the actuation portion 71. Therefore, according to the present example embodiment, the movement of the actuation portion 71 in the axis intersecting direction Da is restricted by the intersecting direction facing portion 30. As a result, malfunction of the actuation portion 71 can be reduced or prevented. Therefore, it is possible to prevent the state in which the axially facing portion 75 and the protruding portion 204 face each other from becoming the non-facing state due to the malfunction of the actuation portion 71 and the coupling state between the first joint 100 and the second joint 200 from becoming the unlocked state.

The actuation portion 71 is pressed to the one side D1 in the axis intersecting direction Da by the elastic portion 11 (FIG. 7). In the state where the axially facing portion 75 and the protruding portion 204 face each other (FIG. 7), the intersecting direction facing portion 30 faces the actuation portion 71 in the axis intersecting direction Da between the socket body 50 and the actuation portion 71. Therefore, the movement of the actuation portion 71 toward the other side D2 in the axis intersecting direction Da is restricted by the intersecting direction facing portion 30.

As illustrated in FIG. 9, the mounting portion 3 is located at a first position P1 in the axial direction AD1. The first position P1 indicates a position where the intersecting direction facing portion 30 faces the actuation portion 71 in the axis intersecting direction Da.

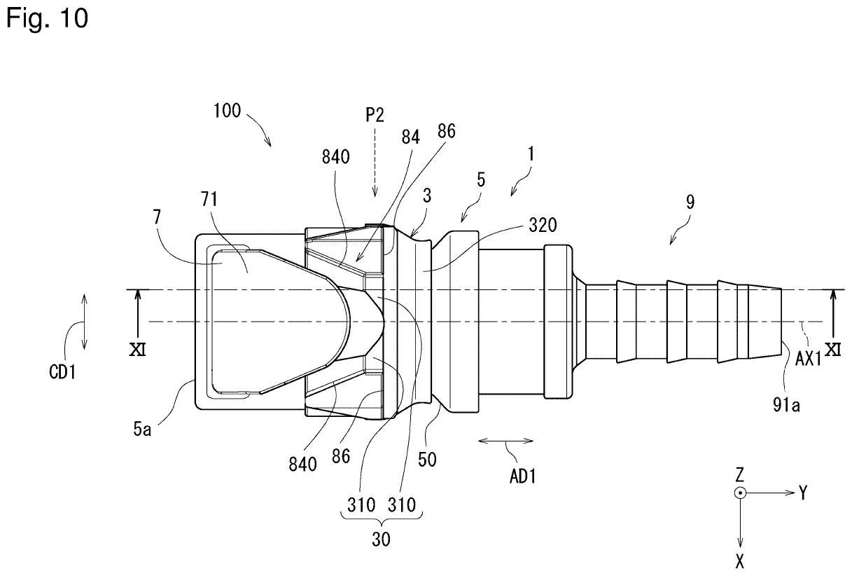

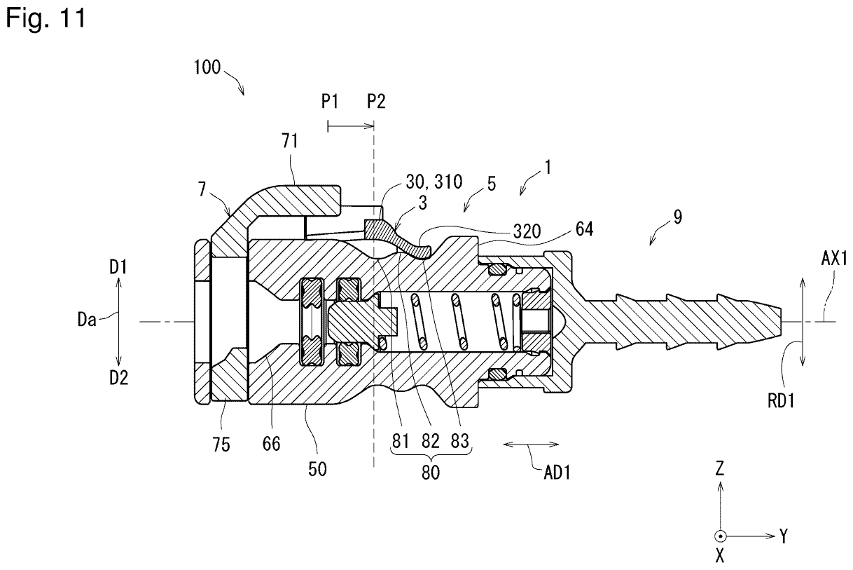

Next, the case where the mounting portion 3 is located at a second position P2 will be described with reference to FIGS. 10 and 11. FIG. 10 is a plan view illustrating the first joint 100 when the mounting portion 3 is located at the second position P2. FIG. 11 is a cross-sectional view taken along line XI-XI of FIG. 10.

As illustrated in FIGS. 10 and 11, the mounting portion 3 is located at the second position P2. The second position P2 indicates a position where the intersecting direction facing portion 30 is separated from the first position P1 in the axial direction AD1. In other words, the second position P2 indicates a position where the intersecting direction facing portion 30 is separated rearward in the axial direction AD1 with respect to the first position P1. In other words, the second position P2 indicates a position where the intersecting direction facing portion 30 does not face the actuation portion 71 in the axis intersecting direction Da. Therefore, when the mounting portion 3 is located at the second position P2, the movement of the actuation portion 7 along the axis intersecting direction Da is not restricted. As a result, the operator can release the lock by the axially facing portion 75 and easily separate the second joint 200 from the first joint 100 by pushing the actuation portion 71 to the other side D2 in the axis intersecting direction Da.

In the present example embodiment, as an example, the position of the mounting portion 3 (the first position P1 and the second position P2) is indicated by the position of the intersecting direction facing portion 30 in the axial direction AD1.

Next, the movement of the mounting portion 3 will be described with reference to FIGS. 8 to 11. The mounting portion 3 is movable between the first position P1 and the second position P2 along the axial direction AD1. Therefore, according to the present example embodiment, the operator can easily switch the coupling state between the first joint 100 and the second joint 200 between the locked state and the unlocked state by moving the mounting portion 3 in the axial direction AD1 between the first position P1 and the second position P2.

In the present example embodiment, as illustrated in FIGS. 9 and 11, the first joint body 1 includes a first restricting portion 80. Specifically, the socket body 50 includes the first restricting portion 80. The first restricting portion 80 restricts the movement of the intersecting direction facing portion 30 between the first position P1 and the second position P2. Therefore, according to the present example embodiment, even when an unexpected force such as vibration is applied to the mounting portion 3, it is possible to suppress the movement of the mounting portion 3 from the first position P1 to the second position P2. As a result, even when an unexpected force such as vibration is applied to the mounting portion 3, the movement of the actuation portion 7 in the axis intersecting direction Da is restricted by the intersecting direction facing portion 30. Therefore, malfunction of the actuation portion 7 is effectively reduced or prevented, and the coupling between the first joint 100 and the second joint 200 can be reduced or prevented from being unintentionally brought into the unlocked state.

Further, in the present example embodiment, the first restricting portion 80 extends in the axial direction AD1 in a cross-sectional view. The first restricting portion 80 has, for example, a wave shape in a cross-sectional view. In the examples of FIGS. 9 and 11, the first restricting portion 80 has a first recess 81 and a convex portion 82. The first recess 81 is recessed inward in the radial direction RD1 with respect to the central axis AX1. The convex portion 82 is connected to the first recess 81. The convex portion 82 protrudes outward in the radial direction RD1. The convex portion 82 is located farther from the actuation portion 71 in the axial direction AD1 than the first recess 81. That is, the convex portion 82 is positioned behind the first recess 81 in the axial direction AD1. According to the present example embodiment, the first restricting portion 80 can be realized by a simple configuration such as the first recess 81 and the convex portion 82. In addition, since the shape of the mounting portion 3 only needs to be matched with the shape of the first restricting portion 80, the mounting portion 3 having a simple configuration can be realized.

Specifically, each of the first recess 81 and the convex portion 82 has an annular shape extending in the circumferential direction CD1. As illustrated in FIG. 9, at the first position P1, a rear end portion 320 in the axial direction AD1 of the mounting portion 3 is fitted into the first recess 81. The convex portion 82 is adjacent to the first recess 81 in the axial direction AD1. Therefore, it is possible to effectively suppress the movement of the mounting portion 3 from the first position P1 to the second position P2 due to vibration or the like.

In the present example embodiment, the first restricting portion 80 further includes a second recess 83. The second recess 83 is recessed inward in the radial direction RD1. The second recess 83 is connected to the convex portion 82. The second recess 83 is located farther from the actuation portion 71 in the axial direction AD1 than the convex portion 82. That is, the second recess 83 is positioned behind the convex portion 82 in the axial direction AD1. The first joint body 1 further includes the overhanging portion 64. The overhanging portion 64 overhangs outward in the radial direction RD1 from an apex VT of the convex portion 82. That is, a maximum outer diameter R1 of the overhanging portion 64 is equal to or larger than a maximum outer diameter R2 of the convex portion 82 (FIG. 6). The overhanging portion 64 is connected to the second recess 83 in the axial direction AD1. The overhanging portion 64 is located farther from the actuation portion 71 in the axial direction AD1 than the second recess 83. That is, the overhanging portion 64 is positioned behind the second recess 83 in the axial direction AD1. Therefore, according to the present example embodiment, as illustrated in FIG. 11, when the mounting portion 3 is located at the second position P2, it is possible to suppress the mounting portion 3 from coming off to the rear side in the axial direction AD1.

Specifically, each of the second recess 83 and the overhanging portion 64 has an annular shape extending in the circumferential direction CD1. As illustrated in FIG. 11, at the second position P2, the rear end portion 320 in the axial direction AD1 of the mounting portion 3 is fitted into the second recess 83. The convex portion 82 is adjacent to the second recess 83 in the axial direction AD1. Therefore, it is possible to effectively suppress the movement of the mounting portion 3 from the second position P2 to the first position P1 due to vibration or the like.

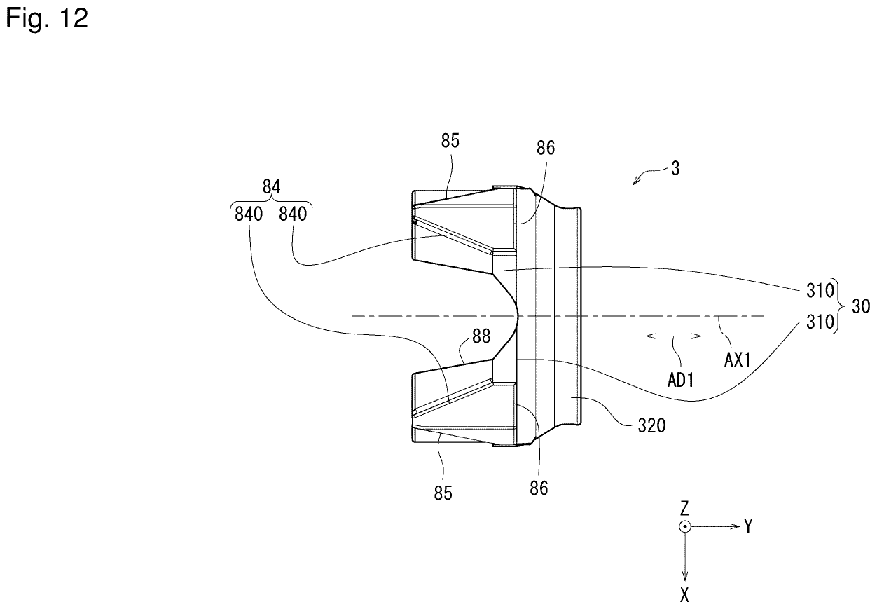

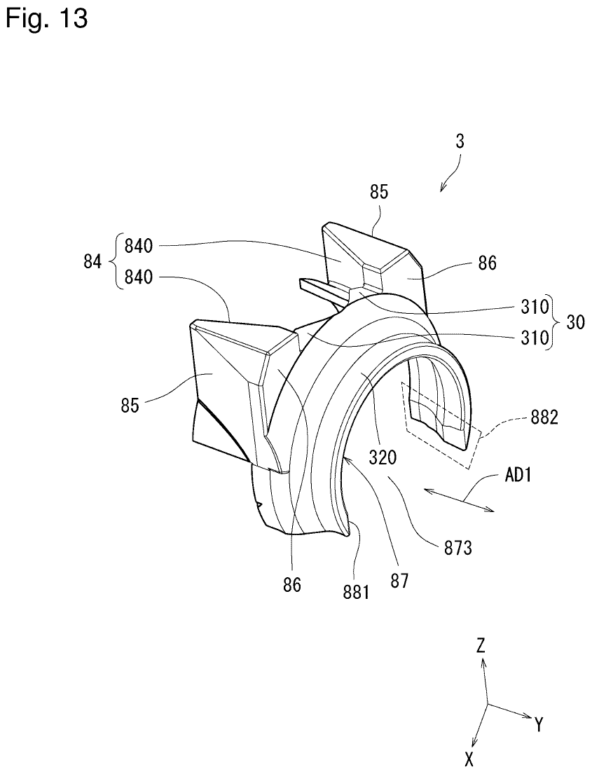

Next, another function of the mounting portion 3 will be described with reference to FIGS. 8, 10, 12, and 13. FIG. 12 is a plan view illustrating the mounting portion 3. FIG. 13 is a perspective view illustrating the mounting portion 3. As illustrated in FIGS. 12 and 13, the mounting portion 3 further includes a second restricting portion 84. As illustrated in FIG. 8, in a state where the mounting portion 3 is located at the first position P1, the second restricting portion 84 faces both end surfaces 710 in the circumferential direction CD1 of the actuation portion 71, in the circumferential direction CD1. Therefore, the second restricting portion 84 restricts the movement of the actuation portion 71 in the circumferential direction CD1. As a result, according to the present example embodiment, it is possible to suppress the intersecting direction facing portion 30 from not facing the actuation portion 71 in the axis intersecting direction Da. As a result, malfunction of the actuation portion 71 can be effectively reduced or prevented.

Specifically, the second restricting portion 84 has a pair of inclined surfaces 840. The inclined surface 840 is inclined with respect to the central axis AX1. The pair of inclined surfaces 840 faces the central axis AX1 from the front end 5a toward the rear end 91a of the first joint body 1. Specifically, the pair of inclined surfaces 840 is inclined with respect to the central axis AX1 so as to approach each other from the front end 5a toward the rear end 91a of the first joint body 1.

In a state where the mounting portion 3 is located at the first position P1, the inclined surface 840 faces the end surface 710 of the actuation portion 71 in the circumferential direction CD1 and comes into contact with the end surface 710.

In particular, in the present example embodiment, as illustrated in FIGS. 8 and 10, in a state where the mounting portion 3 is located at the first position P1 and a state where the mounting portion 3 is located at the second position P2, the second restricting portion 84 faces both end surfaces 710 in the circumferential direction CD1 of the actuation portion 71 in the circumferential direction CD1. Therefore, according to the present example embodiment, even when the mounting portion 3 is located at the second position P2, the actuation portion 71 can be prevented from being displaced in the circumferential direction CD1. As a result, the operator can easily operate the actuation portion 71.

As illustrated in FIG. 10, when the mounting portion 3 is located at the second position P2, the inclined surface 840 of the second restricting portion 84 is separated from the end surface 710 of the actuation portion 71 in the circumferential direction CD1.

Next, still another function of the mounting portion 3 will be described with reference to FIGS. 8, 12, and 13. The mounting portion 3 has a pair of inclined surfaces 85. The inclined surface 85 is inclined with respect to the central axis AX1. The pair of inclined surfaces 85 extends with respect to the central axis AX1 from the front end 5a toward the rear end 91a of the first joint body 1. Therefore, according to the present example embodiment, it is easy for the operator to move the mounting portion 3 from the first position P1 to the second position P2.

Next, still another function of the mounting portion 3 will be described with reference to FIGS. 8, 12, and 13. The mounting portion 3 has a pair of planes 86. The pair of planes 86 intersects with the axial direction AD1. Therefore, according to the present example embodiment, it is easy for the operator to move the mounting portion 3 from the second position P2 to the first position P1.

Next, still another function of the mounting portion 3 will be described with reference to FIGS. 8 and 12. The mounting portion 3 further includes a third recess 88. The third recess 88 is recessed in the axial direction AD1. The elastic portion 11 is disposed to overlap the third recess 88 in the axis intersecting direction Da (FIG. 4). The elastic portion 11 supports the actuation portion 71 in the axis intersecting direction Da. Therefore, according to the present example embodiment, it is possible to suppress contact between the elastic portion 11 and the mounting portion 3. As a result, it is possible to suppress detachment of the elastic portion 11 from the first joint body 1.

Specifically, the third recess 88 is recessed from the front end 5a toward the rear end 91a of the first joint body 1 in the axial direction AD1. The third recess 88 is located between socket body 50 and actuation portion 71.

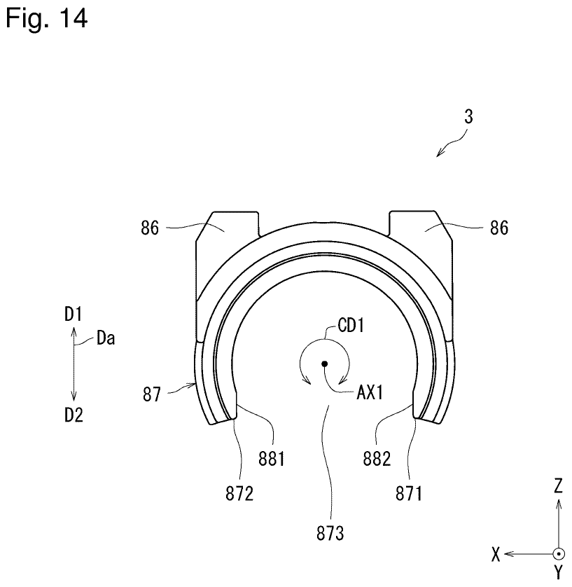

Next, still another function of the mounting portion 3 will be described with reference to FIGS. 4 and 13 to 15. FIG. 14 is a rear view illustrating the mounting portion 3. As illustrated in FIGS. 13 and 14, the mounting portion 3 includes a curved portion 87 and an opening 873. The curved portion 87 is curved along the circumferential direction CD1 with respect to the central axis AX1. As illustrated in FIG. 4, the curved portion 87 is fitted to the outer peripheral surface of the first joint body 1 (socket body 50). Therefore, according to the present example embodiment, the mounting portion 3 can be easily mounted on the first joint body 1, and the mounting portion 3 can be easily removed from the first joint body 1. Even when the overhanging portion 64 is provided, the mounting portion 3 can be easily mounted on the first joint body 1 (socket body 50).

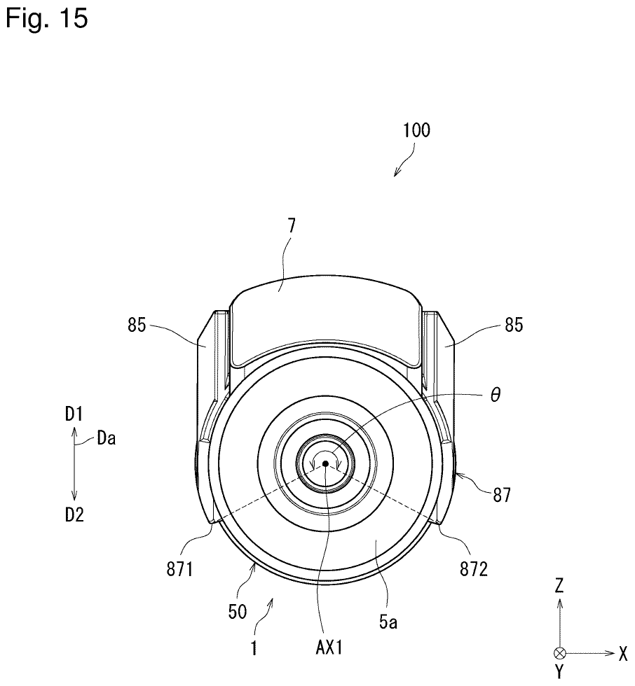

FIG. 15 is a front view illustrating the first joint 100. As illustrated in FIG. 15, in the curved portion 87, an angle θ formed by one end 871 and the other end 872 of the curved portion 87 in the circumferential direction CD1 with respect to the central axis AX1 is 230 degrees or more and 250 degrees or less. Therefore, according to the present example embodiment, the mounting portion 3 can be more easily mounted on the first joint body 1 (socket body 50), and the mounting portion 3 can be reduced or prevented from being detached from the first joint body 1 (socket body 50) due to vibration or the like.

As shown in FIGS. 13 and 14, the curved portion 87 has a first surface portion 881 and a second surface portion 882. The first surface portion 881 is located at one end portion of the curved portion 87 in the circumferential direction CD1. The first surface portion 881 extends along the axis intersecting direction Da. The second surface portion 882 is located at the other end portion of the curved portion 87 in the circumferential direction CD1. The second surface portion 882 extends along the axis intersecting direction Da. The first surface portion 881 and the second surface portion 882 are parallel to each other. Therefore, according to the present example embodiment, since the opening 873 of the curved portion 87 is not curved and the width does not change, the mounting portion 3 can be easily mounted on the first joint body 1 (socket body 50).

### Modification

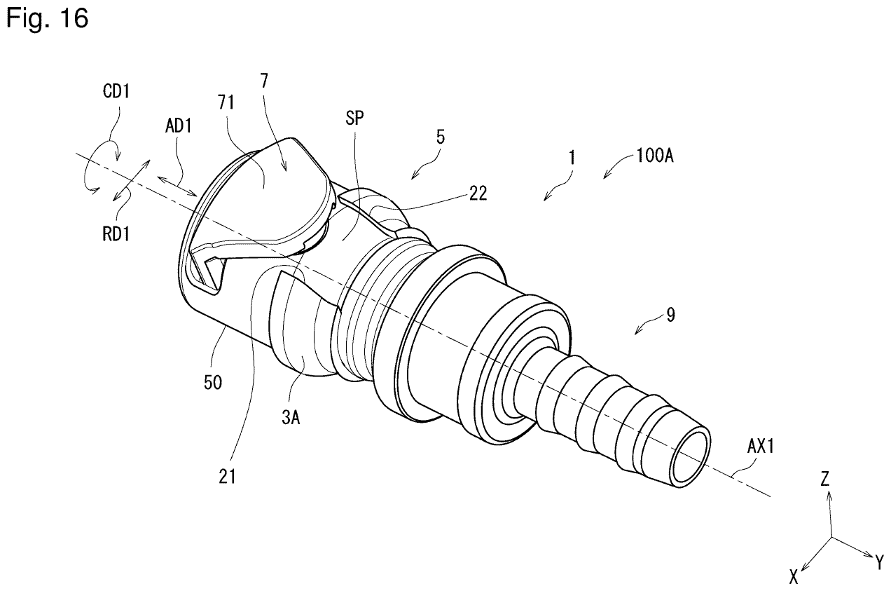

A first joint 100A according to a modification of the first example embodiment will be described with reference to FIGS. 16 to 19. The present modification is mainly different from the first example embodiment in that the mounting portion 3A rotates in the circumferential direction CD1. The different point between the present modification and the first example embodiment will mainly be described below.

FIG. 16 is a perspective view illustrating the first joint 100A according to a modification of the first example embodiment. As illustrated in FIG. 16, the first joint 100A includes a mounting portion 3A. The mounting portion 3A is mounted on the first joint body 1 (socket body 50). The mounting portion 3A is curved along the circumferential direction CD1. One end 21 and the other end 22 of the mounting portion 3A in the circumferential direction CD1 face each other in the circumferential direction CD1. The one end 21 and the other end 22 of the mounting portion 3A are located at a distance in the circumferential direction CD1. Therefore, the mounting portion 3A has a space SP between the one end 21 and the other end 22 of the mounting portion 3A.

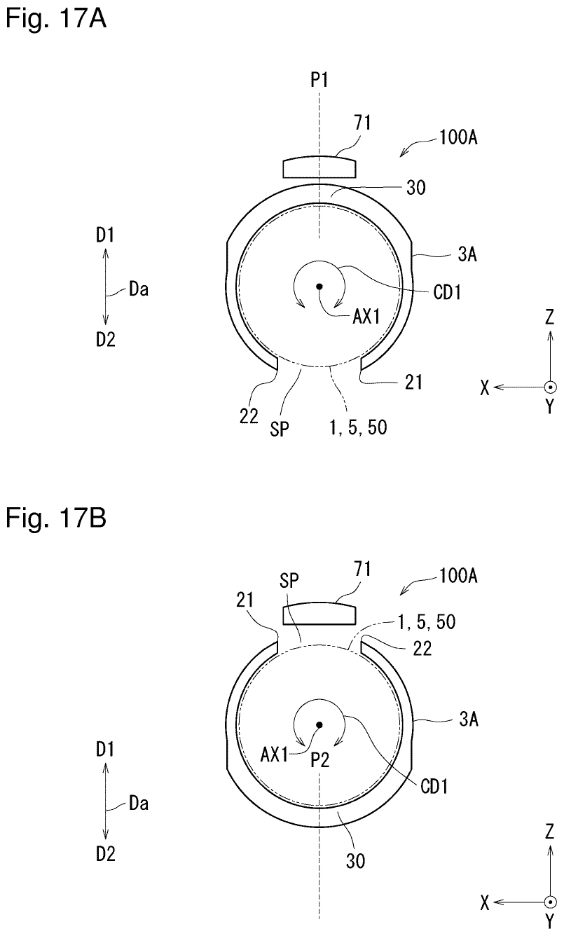

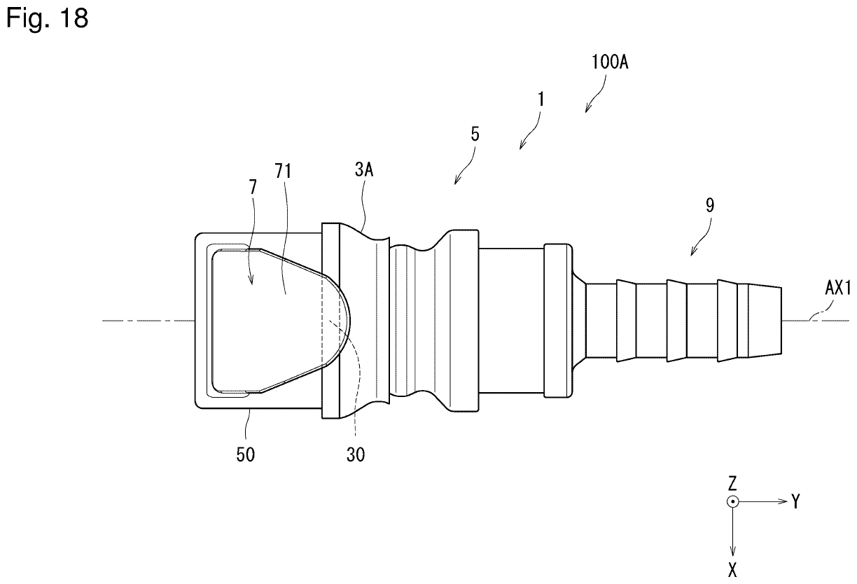

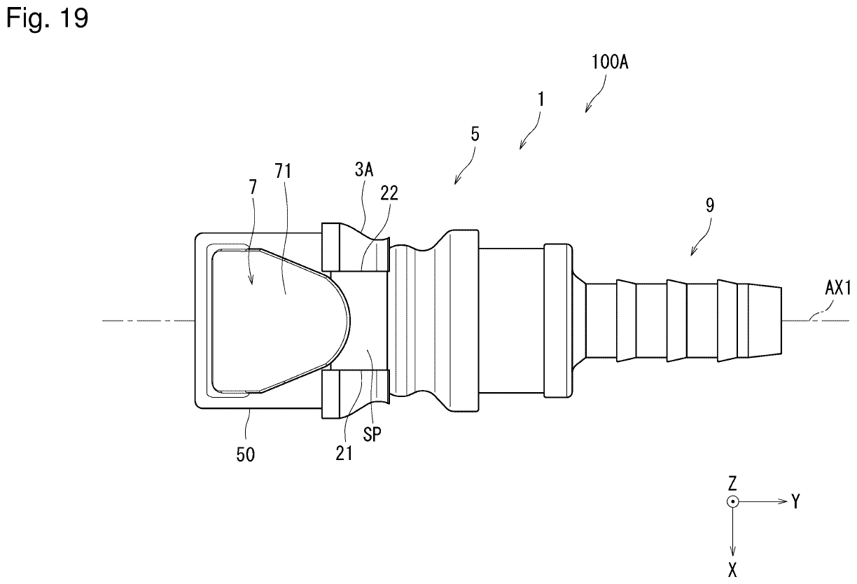

FIG. 17A is a view illustrating a first position P1 of the mounting portion 3A. FIG. 17B is a view illustrating a second position P2 of the mounting portion 3A. FIG. 18 is a diagram illustrating the first joint 100A when the mounting portion 3A is located at the first position P1. FIG. 19 is a diagram illustrating the first joint 100A when the mounting portion 3A is located at the second position P2.

As illustrated in FIGS. 17A and 17B, the mounting portion 3A is rotatable between the first position P1 and the second position P2 along the circumferential direction CD1 with respect to the central axis AX1. The first position P1 indicates a position where the intersecting direction facing portion 30 faces the actuation portion 71 in the axis intersecting direction Da. As illustrated in FIG. 18, at the first position P1, the actuation portion 71 and the intersecting direction facing portion 30 face each other in the axis intersecting direction Da. Therefore, the intersecting direction facing portion 30 restricts the movement of the actuation portion 71 along the axis intersecting direction Da. As a result, malfunction of the actuation portion 7 can be reduced or prevented. The second position P2 indicates a position where the intersecting direction facing portion 30 is separated from the first position P1 in the circumferential direction CD1. As illustrated in FIG. 19, at the second position P2, the actuation portion 71 faces the space SP in the axis intersecting direction Da. Therefore, the movement of the actuation portion 7 along the axis intersecting direction Da is not restricted. As a result, the operator can easily release the lock by pushing the actuation portion 7 to the other side D2 in the axis intersecting direction Da. The first position P1 and the second position P2 are separated from each other in the circumferential direction CD1 with respect to the central axis AX1.

As described above with reference to FIGS. 16 to 19, according to the present modification, the coupling state between the first joint 100A and the second joint 200 can be easily switched between the locked state and the unlocked state by rotating the mounting portion 3A in the circumferential direction CD1.

### Second Example Embodiment

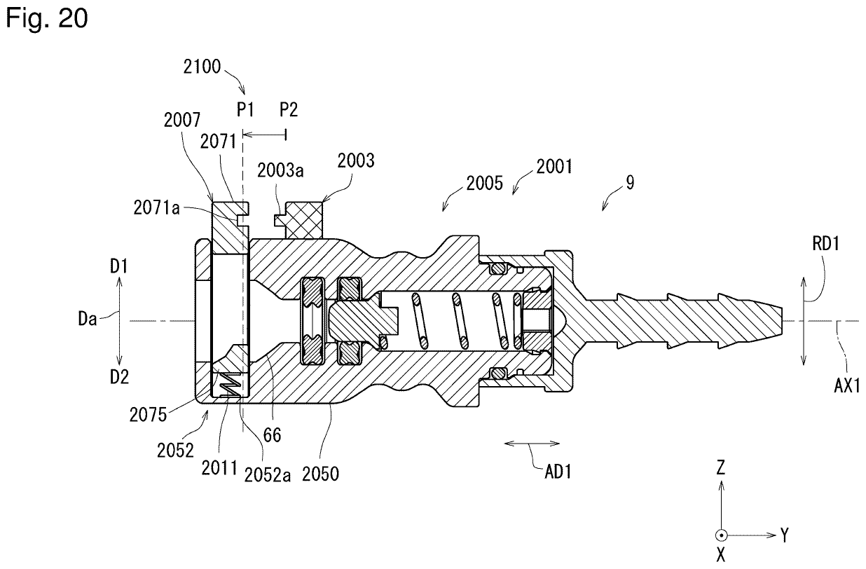

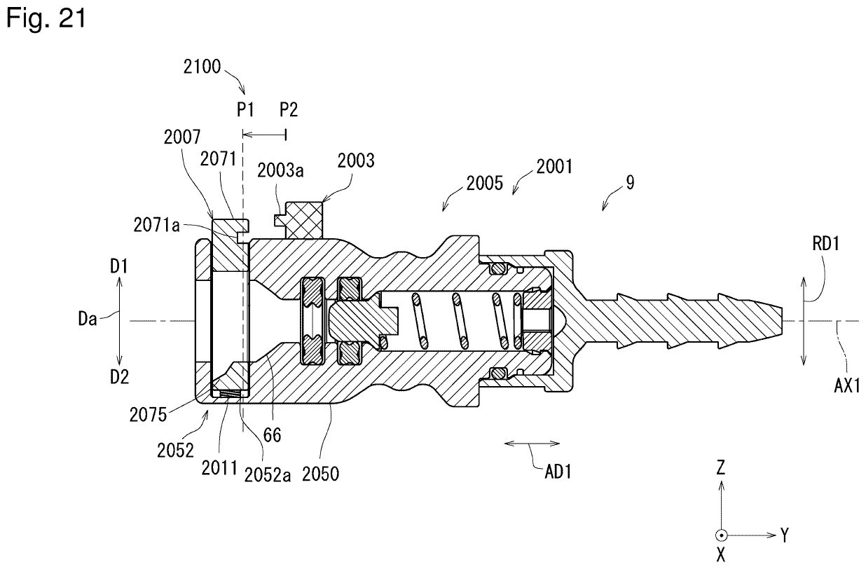

A first joint 2100 according to a second example embodiment of the present disclosure will be described with reference to FIGS. 20 to 22. FIGS. 20 and 21 are cross-sectional views illustrating the first joint 2100 according to the second example embodiment. FIGS. 20 and 21 illustrate a state in which the first joint 2100 is separated from the second joint 200. FIG. 20 illustrates an actuation portion 2007 when located at an initial position Z0. FIG. 21 illustrates the actuation portion 2007 when located at an open position Z1.

In the first joint 100 according to the first example embodiment, the intersecting direction facing portion 30 of the mounting portion 3 faces the actuation portion 71 in the axis intersecting direction Da between the first joint body 1 and the actuation portion 71, whereas in the first joint 2100 according to the second example embodiment, a mounting portion 2003 has a mounting portion protruding portion 2003a disposed in a hole 2071a of an actuation portion 2071. Hereinafter, in the second example embodiment, matters different from those in the first example embodiment will be described, and the duplicated part of the first example embodiment will not be described.

The first joint 2100 includes a first joint body 2001, the mounting portion 2003, the actuation portion 2071, and an elastic portion 2011. Specifically, the first joint 2100 includes an actuation portion 2007. The actuation portion 2007 includes the actuation portion 2071. The actuation portion 2071 has a hole 2071a. The hole 2071a only needs to extend along the axial direction AD1 and may or may not penetrate the actuation portion 2071, and has, for example, a cylindrical shape.

The first joint body 2001 extends along the axial direction AD1. The first joint body 2001 is coupled to the second joint 200 along the central axis AX1. The mounting portion 2003 is mounted on the outer peripheral surface of the first joint body 2001. The actuation portion 2007 is operated by an operator to switch the coupling state between the first joint body 2001 and the second joint 200 between the locked state and the unlocked state. The elastic portion 2011 supports the actuation portion 2007. As an example, the actuation portion 2007 (actuation portion 2071) and the elastic portion 2011 constitute a push button.

Specifically, the first joint body 2001 includes a socket part 2005 and an insertion part 9. The socket part 2005 has a socket body 2050.

With continued reference to FIGS. 20 and 21, the configuration related to the actuation portion 2007 and the actuation portion 2007 will be described. The socket body 2050 further includes accommodating portion 2052. In the accommodating portion 2052, a through hole is provided on one side D1 of the socket body 2050 in the axis intersecting direction Da, and the inner peripheral surface on the other side D2 of the socket body 2050 in the axis intersecting direction Da is recessed in the axis intersecting direction Da. The actuation portion 2007 is disposed in the accommodating portion 2052 along the axis intersecting direction Da. The elastic portion 2011 is disposed in the accommodating portion 2052 along the axis intersecting direction Da. The elastic portion 2011 has elasticity. The elastic portion 2011 is, for example, a compression coil spring. The elastic portion 2011 extends and contracts in the axis intersecting direction Da. The elastic portion 2011 is disposed between the actuation portion 2007 and a bottom surface 2052a of the accommodating portion 2052. The elastic portion 2011 supports the actuation portion 2007.

The actuation portion 2007 further includes a pair of connecting portions (not illustrated) and an axially facing portion 2075. The pair of connecting portions connects the actuation portion 2071 and the axially facing portion 2075.

In a state where the actuation portion 2007 is disposed in the accommodating portion 2052, the elastic portion 2011 pushes the actuation portion 2071 toward the one side D1 in the axis intersecting direction Da. At the initial position Z0, the axially facing portion 2075 faces the protrusion arrangement portion 66 in the axial direction AD1. That is, at the initial position Z0, the axially facing portion 2075 is located in front of the protrusion arrangement portion 66 in the axial direction AD1. Therefore, the coupling state between the first joint 2100 and the second joint 200 becomes the locked state.

On the other hand, when a force is applied to the actuation portion 2007 toward the other side D2 in the axis intersecting direction Da in a state where the actuation portion 2007 is disposed in the accommodating portion 2052, the actuation portion 2007 moves from the initial position Z0 toward the other side D2 in the axis intersecting direction Da against the elastic force of the elastic portion 2011. As a result, the axially facing portion 2075 moves from the initial position Z0 to the open position Z1 and stands still. At the open position Z1, the axially facing portion 2075 is located on the other side D2 in the axis intersecting direction Da with respect to the protrusion arrangement portion 66. Therefore, at the open position Z1, the axially facing portion 2075 does not face the protrusion arrangement portion 66 in the axial direction AD1. As a result, the front side in the axial direction AD1 of the protrusion arrangement portion 66 is opened at the open position Z1. Therefore, the coupling state between the first joint 2100 and the second joint 200 becomes the unlocked state.

When the force on the actuation portion 2007 is released, due to the elastic force of the elastic portion 2011, the actuation portion 2007 moves toward the one side D1 in the axis intersecting direction Da. That is, the actuation portion 2007 returns to the initial position Z0.

As described above with reference to FIGS. 20 and 21, the actuation portion 2071 is actuated along the axis intersecting direction Da to switch between the facing state and the non-facing state of the axially facing portion 2075 and the protruding portion 204 in the axial direction AD1.

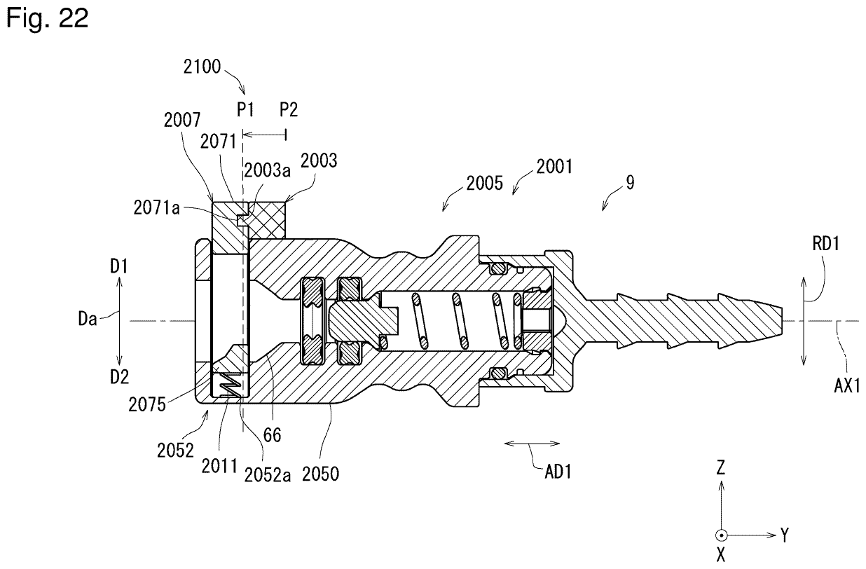

The first joint 2100 according to the second example embodiment will be described with reference to FIGS. 20 to 22. FIG. 22 is a cross-sectional view illustrating the first joint 2100 according to the second example embodiment. FIG. 22 illustrates a state in which the first joint 2100 is separated from the second joint 200. FIG. 22 illustrates the actuation portion 2007 when located at the initial position Z0.

As illustrated in FIGS. 20 to 22, the mounting portion 2003 has a mounting portion protruding portion 2003a. The mounting portion protruding portion 2003a is an example of a mounting portion restricting portion. The shape of the mounting portion protruding portion 2003a is not particularly limited as long as it can be inserted into the hole 2071a, and is, for example, a cylindrical body.

The mounting portion protruding portion 2003a is disposed in the hole 2071a of the actuation portion 2071 in a state where the axially facing portion 2075 and the protruding portion 204 face each other. Therefore, according to the second example embodiment, the movement of the actuation portion 2071 in the axis intersecting direction Da is restricted by the mounting portion protruding portion 2003a. As a result, malfunction of the actuation portion 2071 can be reduced or prevented. Therefore, it is possible to prevent a state in which the axially facing portion 2075 and the protruding portion 204 face each other from becoming the non-facing state due to the malfunction of the actuation portion 2071 and the coupling state between the first joint 2100 and the second joint 200 from becoming the unlocked state.

The mounting portion 2003 is located at the first position P1 in the axial direction AD1. The first position P1 indicates a position where the mounting portion protruding portion 2003a is disposed in the hole 2071a. The first position P1 indicates the position of the mounting portion 2003 in FIG. 22.

On the other hand, the mounting portion 2003 is located at the second position P2. The second position P2 indicates a position where the mounting portion protruding portion 2003a is separated from the first position P1 in the axial direction AD1. In other words, the second position P2 indicates a position where the mounting portion protruding portion 2003a is separated rearward in the axial direction AD1 with respect to the first position P1. In other words, the second position P2 indicates a position where the mounting portion protruding portion 2003a is not disposed in the hole 2071a. The second position P2 indicates the position of the mounting portion 2003 in FIGS. 20 and 21. Therefore, when the mounting portion 2003 is located at the second position P2, the movement of the actuation portion 2007 along the axis intersecting direction Da is not restricted. As a result, the operator can release the lock by the axially facing portion 2075 and easily separate the second joint 200 from the first joint 2100 by pushing the actuation portion 2071 to the other side D2 in the axis intersecting direction Da.

In the second example embodiment, as an example, the position of the mounting portion 2003 (the first position P1 and the second position P2) is indicated by the position of the mounting portion protruding portion 2003a in the axial direction AD1.

Next, movement of the mounting portion 2003 will be described. The mounting portion 2003 is movable between the first position P1 and the second position P2 along the axial direction AD1. Therefore, according to the second example embodiment, the operator can easily switch the coupling state between the first joint 2100 and the second joint 200 between the locked state and the unlocked state by moving the mounting portion 2003 in the axial direction AD1 between the first position P1 and the second position P2.

### Third Example Embodiment

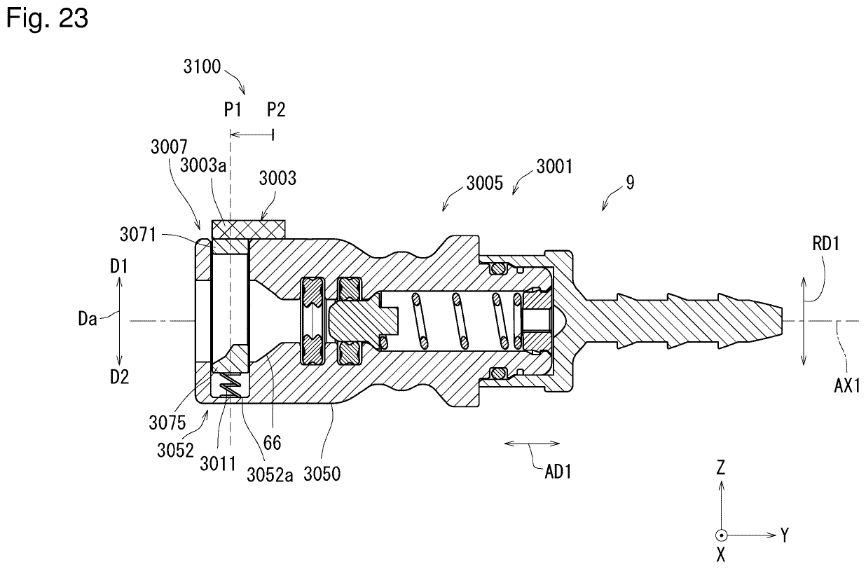

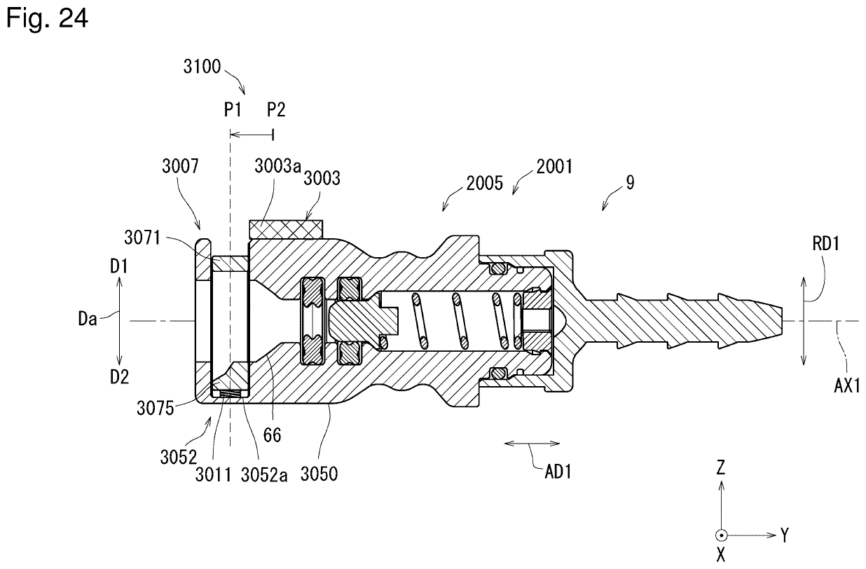

A first joint 3100 according to a third example embodiment of the present disclosure will be described with reference to FIGS. 23 and 24. FIGS. 23 and 24 are cross-sectional views illustrating the first joint 3100 according to the third example embodiment. FIGS. 23 and 24 illustrate a state in which the first joint 3100 is separated from the second joint 200. FIG. 23 illustrates the actuation portion 3007 when located at the initial position Z0, and the mounting portion 3003 when located at the first position P1. FIG. 24 illustrates the actuation portion 3007 when located at the open position Z1 and the mounting portion 3003 when located at the second position P2.

In the first joint 2100 according to the second example embodiment, the mounting portion 2003 has the mounting portion protruding portion 2003a disposed in the hole 2071a of the actuation portion 2071. On the other hand, in the first joint 3100 according to the third example embodiment, the mounting portion 3003 has a cover portion 3003a disposed on the outer side in the radial direction RD1 with respect to the surface on the outer side in the radial direction RD1 of the actuation portion 3071. Hereinafter, in the third example embodiment, matters different from those in the second example embodiment will be described, and the duplicated part of the second example embodiment will not be described.

The first joint 3100 includes a first joint body 3001, a mounting portion 3003, an actuation portion 3071, and an elastic portion 3011. Specifically, the first joint 3100 includes an actuation portion 3007. The actuation portion 3007 has the actuation portion 3071.

The first joint body 3001 extends along the axial direction AD1. The first joint body 3001 is coupled to the second joint 200 along the central axis AX1. The mounting portion 3003 is mounted on the outer peripheral surface of the first joint body 3001. The actuation portion 3007 is operated by an operator to switch the coupling state between the first joint body 3001 and the second joint 200 between the locked state and the unlocked state. The elastic portion 3011 supports the actuation portion 3007. As an example, the actuation portion 3007 (actuation portion 3071) and the elastic portion 3011 constitute a push button.

Specifically, the first joint body 3001 includes a socket part 3005 and an insertion part 9. The socket part 3005 has a socket body 3050.

With continued reference to FIGS. 23 and 24, the configuration related to the actuation portion 3007 and the actuation portion 3007 will be described. The socket body 3050 further includes an accommodating portion 3052. In the accommodating portion 3052, a through hole is provided on one side D1 of the socket body 3050 in the axis intersecting direction Da, and the inner peripheral surface on the other side D2 of the socket body 3050 in the axis intersecting direction Da is recessed in the axis intersecting direction Da. The actuation portion 3007 is disposed in the accommodating portion 3052 along the axis intersecting direction Da. The elastic portion 3011 is disposed in the accommodating portion 3052 along the axis intersecting direction Da. The elastic portion 3011 is disposed between the actuation portion 3007 and a bottom surface 3052a of the accommodating portion 3052.

The actuation portion 3007 further includes a pair of connecting portions (not illustrated) and an axially facing portion 3075. The pair of connecting portions connects the actuation portion 3071 and the axially facing portion 3075.

In a state where the actuation portion 3007 is disposed in the accommodating portion 3052, the elastic portion 3011 pushes the actuation portion 3071 toward the one side D1 in the axis intersecting direction Da. At the initial position Z0, the axially facing portion 3075 faces the protrusion arrangement portion 66 in the axial direction AD1. That is, at the initial position Z0, the axially facing portion 3075 is located in front of the protrusion arrangement portion 66 in the axial direction AD1. Therefore, the coupling state between the first joint 3100 and the second joint 200 becomes the locked state. At the initial position Z0, the outer surface of the actuation portion 3007 in the radial direction RD1 is substantially flush with the outer surface of the first joint body 3001 in the radial direction RD1. Note that the outer surface in the radial direction RD1 of the actuation portion 3007 may be disposed on the inner side in the radial direction RD1 with respect to the outer surface in the radial direction RD1 of the first joint body 3001.

On the other hand, when a force is applied to the actuation portion 3007 toward the other side D2 in the axis intersecting direction Da in a state where the actuation portion 3007 is disposed in the accommodating portion 3052, the actuation portion 3007 moves from the initial position Z0 toward the other side D2 in the axis intersecting direction Da against the elastic force of the elastic portion 3011. As a result, the axially facing portion 3075 moves from the initial position Z0 to the open position Z1 and stands still. At the open position Z1, the axially facing portion 3075 is located on the other side D2 in the axis intersecting direction Da with respect to the protrusion arrangement portion 66. Therefore, at the open position Z1, the axially facing portion 3075 does not face the protrusion arrangement portion 66 in the axial direction AD1. As a result, the front side in the axial direction AD1 of the protrusion arrangement portion 66 is opened at the open position Z1. Therefore, the coupling state between the first joint 3100 and the second joint 200 becomes the unlocked state.

When the force on the actuation portion 3007 is released, due to the elastic force of the elastic portion 3011, the actuation portion 3007 moves toward the one side D1 in the axis intersecting direction Da. That is, the actuation portion 3007 returns to the initial position Z0.

As described above with reference to FIGS. 23 and 24, the actuation portion 3071 is actuated along the axis intersecting direction Da to switch between the facing state and the non-facing state of the axially facing portion 3075 and the protruding portion 204 in the axial direction AD1.

As illustrated in FIGS. 23 and 24, the mounting portion 3003 includes a cover portion 3003a. The cover portion 3003a is an example of a mounting portion restricting portion. The cover portion 3003a is, for example, a plate-like body.

The cover portion 3003a is disposed on the outer side in the radial direction RD1 with respect to the outer surface in the radial direction RD1 of the actuation portion 3071 in the state where the axially facing portion 3075 and the protruding portion 204 face each other. That is, the cover portion 3003a covers the outer surface in the radial direction RD1 of the actuation portion 3071. Therefore, according to the third example embodiment, contact with the actuation portion 3071 is inhibited by the cover portion 3003a. In other words, according to the third example embodiment, the cover portion 3003a restricts the movement of the actuation portion 3071 in the axis intersecting direction Da. As a result, malfunction of the actuation portion 3071 can be reduced or prevented. Therefore, it is possible to prevent a state in which the axially facing portion 3075 and the protruding portion 204 face each other from becoming the non-facing state due to the malfunction of the actuation portion 3071 and the coupling state between the first joint 3100 and the second joint 200 from becoming the unlocked state.

The mounting portion 3003 is located at the first position P1 in the axial direction AD1. The first position P1 indicates a position where the cover portion 3003a faces the actuation portion 3071 in the axis intersecting direction Da. The first position P1 indicates the position of the mounting portion 3003 in FIG. 23.

On the other hand, the mounting portion 3003 is located at the second position P2. The second position P2 indicates a position where the cover portion 3003a is separated from the first position P1 in the axial direction AD1. In other words, the second position P2 indicates a position where the cover portion 3003a is separated rearward in the axial direction AD1 with respect to the first position P1. In other words, the second position P2 indicates a position where the cover portion 3003a does not face the actuation portion 3071 in the axis intersecting direction Da. The second position P2 indicates the position of the mounting portion 3003 in FIG. 24. Therefore, when the mounting portion 3003 is located at the second position P2, contact with the actuation portion 3007 is not hindered. As a result, the operator can release the lock by the axially facing portion 3075 and easily separate the second joint 200 from the first joint 3100 by pushing the actuation portion 3071 to the other side D2 in the axis intersecting direction Da.

In the third example embodiment, as an example, the position (the first position P1 and the second position P2) of the mounting portion 3003 is indicated by the position of the cover portion 3003a in the axial direction AD1.

Next, movement of the mounting portion 3003 will be described. The mounting portion 3003 is movable between the first position P1 and the second position P2 along the axial direction AD1. Therefore, according to the third example embodiment, the operator can easily switch the coupling state between the first joint 3100 and the second joint 200 between the locked state and the unlocked state by moving the mounting portion 3003 in the axial direction AD1 along the outer surface in the radial direction RD1 of the socket body 3050 between the first position P1 and the second position P2.

### Fourth Example Embodiment

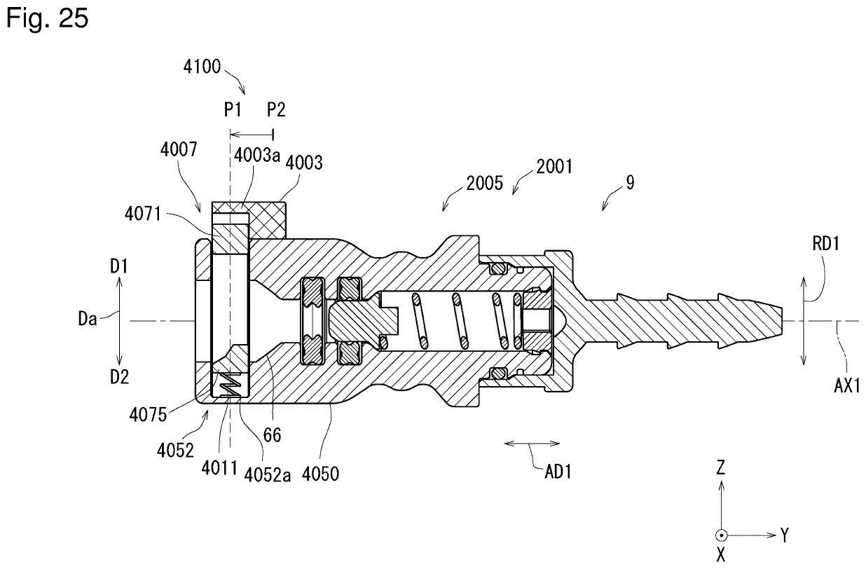

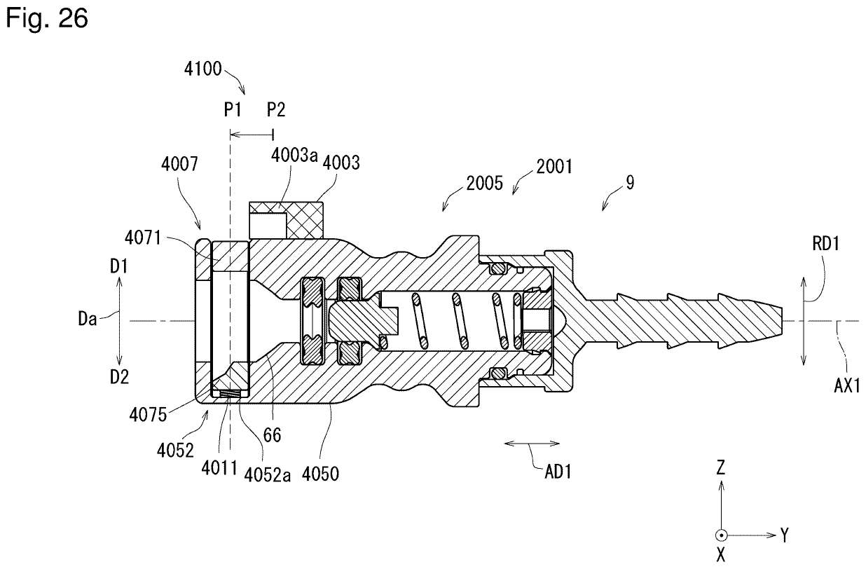

A first joint 4100 according to a fourth example embodiment of the present disclosure will be described with reference to FIGS. 25 to 27. FIGS. 25 and 26 are cross-sectional views illustrating the first joint 4100 according to the fourth example embodiment. FIGS. 25 and 26 illustrate a state in which the first joint 4100 is separated from the second joint 200. FIG. 25 illustrates an actuation portion 4007 when located at the initial position Z0, and a mounting portion 4003 when located at the first position P1. FIG. 26 illustrates the actuation portion 4007 when located at the open position Z1, and the mounting portion 4003 when located at the second position P2.

In the first joint 3100 according to the third example embodiment, the inner surface in the radial direction RD1 of the cover portion 3003a and the outer surface in the radial direction RD1 of the actuation portion 3071 are in contact with each other at the first position P1, whereas in the first joint 4100 according to the fourth example embodiment, the inner surface in the radial direction RD1 of the cover portion 4003a and the outer surface in the radial direction RD1 of an actuation portion 4071 face each other with a space therebetween at the first position P1. Hereinafter, in the fourth example embodiment, matters different from those in the third example embodiment will be described, and the duplicated part of the third example embodiment will not be described.

The first joint 4100 includes a first joint body 4001, the mounting portion 4003, the actuation portion 4071, and an elastic portion 4011. Specifically, the first joint 4100 includes the actuation portion 4007. The actuation portion 4007 has the actuation portion 4071.

The first joint body 4001 extends along the axial direction AD1. The first joint body 4001 is coupled to the second joint 200 along the central axis AX1. The mounting portion 4003 is mounted on the outer peripheral surface of the first joint body 4001. The actuation portion 4007 is operated by an operator to switch the coupling state between the first joint body 4001 and the second joint 200 between the locked state and the unlocked state. The elastic portion 4011 supports the actuation portion 4007. As an example, the actuation portion 4007 (actuation portion 4071) and the elastic portion 4011 constitute a push button.

Specifically, the first joint body 4001 includes a socket part 4005 and an insertion part 9. The socket part 4005 has a socket body 4050.

With continued reference to FIG. 25, the configuration related to the actuation portion 4007 and the actuation portion 4007 will be described. The socket body 4050 further includes an accommodating portion 4052. In the accommodating portion 4052, a through hole is provided on one side D1 of the socket body 4050 in the axis intersecting direction Da, and the inner peripheral surface on the other side D2 of the socket body 4050 in the axis intersecting direction Da is recessed in the axis intersecting direction Da. The actuation portion 4007 is disposed in the accommodating portion 4052 along the axis intersecting direction Da. The elastic portion 4011 is disposed in the accommodating portion 4052 along the axis intersecting direction Da. The elastic portion 4011 is disposed between the actuation portion 4007 and a bottom surface 4052a of the accommodating portion 4052.

The actuation portion 4007 further includes a pair of connecting portions (not illustrated) and an axially facing portion 4075. The pair of connecting portions connects the actuation portion 4071 and the axially facing portion 4075.

In a state where the actuation portion 4007 is disposed in the accommodating portion 4052, the elastic portion 4011 pushes the actuation portion 4071 toward the one side D1 in the axis intersecting direction Da. At the initial position Z0, the axially facing portion 4075 faces the protrusion arrangement portion 66 in the axial direction AD1. That is, at the initial position Z0, the axially facing portion 4075 is located in front of the protrusion arrangement portion 66 in the axial direction AD1. Therefore, the coupling state between the first joint 4100 and the second joint 200 becomes a locked state. At the initial position Z0, the outer surface in the radial direction RD1 of the actuation portion 4007 is disposed on the radially outer side of the outer surface in the radial direction RD1 of the first joint body 4001.

On the other hand, when a force is applied to the actuation portion 4007 toward the other side D2 in the axis intersecting direction Da in a state where the actuation portion 4007 is disposed in the accommodating portion 4052, the actuation portion 4007 moves from the initial position Z0 toward the other side D2 in the axis intersecting direction Da against the elastic force of the elastic portion 4011. As a result, the axially facing portion 4075 moves from the initial position Z0 to the open position Z1 and stands still. At the open position Z1, the axially facing portion 4075 is located on the other side D2 in the axis intersecting direction Da with respect to the protrusion arrangement portion 66. Therefore, at the open position Z1, the axially facing portion 4075 does not face the protrusion arrangement portion 66 in the axial direction AD1. As a result, the front side in the axial direction AD1 of the protrusion arrangement portion 66 is opened at the open position Z1. Therefore, the coupling state between the first joint 4100 and the second joint 200 becomes an unlocked state.

When the force on the actuation portion 4007 is released, due to the elastic force of the elastic portion 4011, the actuation portion 4007 moves toward the one side D1 in the axis intersecting direction Da. That is, the actuation portion 4007 returns to the initial position Z0.

As described above with reference to FIGS. 25 and 26, the actuation portion 4071 is actuated along the axis intersecting direction Da to switch between the facing state and the non-facing state of the axially facing portion 4075 and the protruding portion 204 in the axial direction AD1.

As illustrated in FIGS. 25 and 26, the mounting portion 4003 includes a cover portion 4003a. The cover portion 4003a is an example of a mounting portion restricting portion. The cover portion 4003a is, for example, a plate-like body.

The cover portion 4003a is disposed on the outer side in the radial direction RD1 with respect to the outer surface in the radial direction RD1 of the actuation portion 4071 in the state where the axially facing portion 4075 and the protruding portion 204 face each other. That is, the cover portion 4003a covers the outer surface in the radial direction RD1 of the actuation portion 4071. Therefore, according to the fourth example embodiment, contact with the actuation portion 4071 is inhibited by the cover portion 4003a. In other words, according to the fourth example embodiment, the cover portion 4003a restricts the movement of the actuation portion 4071 in the axis intersecting direction Da. As a result, malfunction of the actuation portion 4071 can be reduced or prevented. Therefore, it is possible to prevent a state in which the axially facing portion 4075 and the protruding portion 204 face each other from becoming the non-facing state due to the malfunction of the actuation portion 4071 and the coupling state between the first joint 4100 and the second joint 200 from becoming the unlocked state.

The mounting portion 4003 is located at the first position P1 in the axial direction AD1. The first position P1 indicates a position where the cover portion 4003a faces the actuation portion 4071 in the axis intersecting direction Da. Specifically, at the first position P1, the inner surface of the cover portion 4003a in the radial direction RD1 and the outer surface of the actuation portion 4071 in the radial direction RD1 face each other with a space therebetween. The first position P1 indicates the position of the mounting portion 4003 in FIG. 25.

On the other hand, the mounting portion 4003 is located at the second position P2. The second position P2 indicates a position where the cover portion 4003a is separated from the first position P1 in the axial direction AD1. In other words, the second position P2 indicates a position where the cover portion 4003a is separated rearward in the axial direction AD1 with respect to the first position P1. In other words, the second position P2 indicates a position where the cover portion 4003a does not face the actuation portion 4071 in the axis intersecting direction Da. The second position P2 indicates the position of the mounting portion 4003 in FIG. 26. Therefore, when the mounting portion 4003 is located at the second position P2, contact with the actuation portion 4007 is not hindered. As a result, the operator can release the lock by the axially facing portion 4075 and easily separate the second joint 200 from the first joint 4100 by pushing the actuation portion 4071 to the other side D2 in the axis intersecting direction Da.

In the fourth example embodiment, as an example, the position (the first position P1 and the second position P2) of the mounting portion 4003 is indicated by the position of the cover portion 4003a in the axial direction AD1.

Next, movement of the mounting portion 4003 will be described. The mounting portion 4003 is movable between the first position P1 and the second position P2 along the axial direction AD1. Therefore, according to the fourth example embodiment, the operator can easily switch the coupling state between the first joint 4100 and the second joint 200 between the locked state and the unlocked state by moving the mounting portion 4003 in the axial direction AD1 between the first position P1 and the second position P2. In addition, even when the cover portion 4003a is bent by an external force, it is possible to suppress contact with the actuation portion 4071 and to suppress malfunction of the actuation portion 4071.

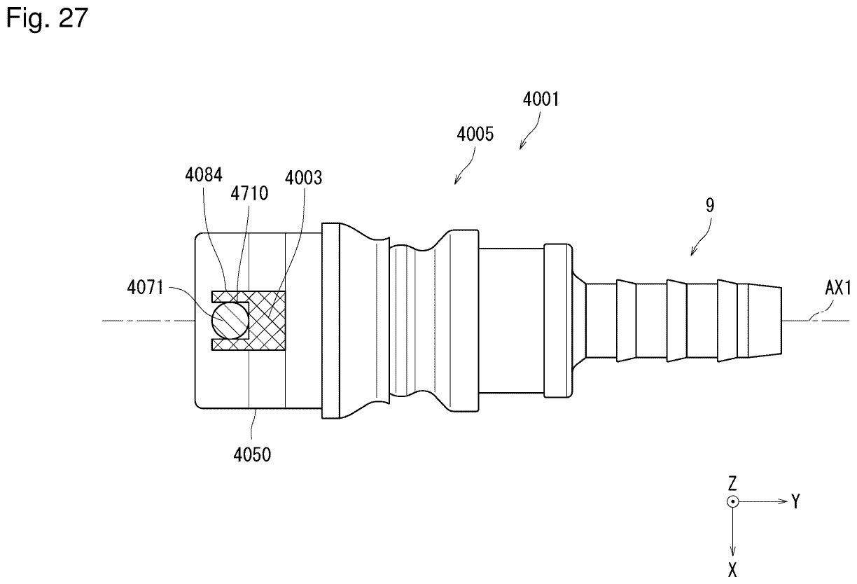

Next, another function of the mounting portion 4003 will be described with reference to FIG. 27. FIG. 27 is a cross-sectional view illustrating the mounting portion 4003. As illustrated in FIG. 27, the mounting portion 4003 further includes a movement restricting portion 4084. The movement restricting portion 4084 is, for example, a pair of side walls. Each of the pair of side walls extends from an end of the cover portion 4003a along the axis intersecting direction Da. Specifically, in a state where the mounting portion 4003 is located at the first position P1, the movement restricting portion 4084 faces both end surfaces 4710 in the circumferential direction CD1 of the actuation portion 4071 in the circumferential direction CD1. Therefore, the movement restricting portion 4084 restricts the movement of the mounting portion 4003 in the circumferential direction CD1. As a result, according to the fourth example embodiment, it is possible to suppress the cover portion 4003a from not facing the actuation portion 4071 in the axis intersecting direction Da. As a result, malfunction of the actuation portion 4071 can be effectively reduced or prevented.

In addition, in a state where the mounting portion 4003 is located at the first position P1, the movement restricting portion 4084 faces the end surface 4710 of the actuation portion 4071 in the circumferential direction CD1 and comes into contact with the end surface 4710.

The example embodiments of the present disclosure are described above with reference to the drawings. However, the present disclosure is not limited to the above example embodiments, and can be implemented in various modes without departing from the gist of the present disclosure. The plurality of elements disclosed in the above example embodiments can be appropriately modified. For example, one element of all elements illustrated in one example embodiment may be added to an element of another example embodiment, or some elements of all elements illustrated in one example embodiment may be eliminated from the example embodiment.

Further, the drawings schematically illustrate each element mainly in order to facilitate understanding of the disclosure, and the thickness, length, number, interval, and the like of the illustrated elements may be different from the actual ones for convenience of creation of the drawings. The configuration of each element shown in the above example embodiments is an example and is not particularly limited, and it goes without saying that various modifications can be made without substantially departing from the effects of the present disclosure.

[1] The mounting portion 3 or 3A may be disposed on the second joint 200.

Note that the present techniques, example embodiments, or modifications thereof, can have any of the configurations described below.

(1) A first joint having a central axis and extending in an axial direction along the central axis, the first joint including a first joint body to be coupled to a second joint along the central axis, an axially facing portion that opposes a protruding portion protruding from an outer peripheral surface of the second joint in the axial direction from a front end side in the axial direction of the first joint body in a state in which the first joint body is coupled to the second joint, an actuation portion that is connected to the axially facing portion and is actuated along an axis intersecting direction intersecting the central axis to switch between a facing state and a non-facing state of the axially facing portion and the protruding portion in the axial direction, and a mounting portion to be mounted on an outer peripheral surface of the first joint body, wherein the mounting portion includes an actuation portion restricting portion to restrict movement of the actuation portion in the facing state of the axially facing portion and the protruding portion.

(2) A first joint having a central axis and extending in an axial direction along the central axis, the first joint including a first joint body to be coupled to a second joint along the central axis, an axially facing portion that faces a protruding portion protruding from an outer peripheral surface of the second joint in the axial direction from a front end side in the axial direction of the first joint body in a state in which the first joint body is coupled to the second joint, an actuation portion that is connected to the axially facing portion and is actuated along an axis intersecting direction intersecting the central axis to switch between a facing state and a non-facing state of the axially facing portion and the protruding portion in the axial direction, and a mounting portion to be mounted on an outer peripheral surface of the first joint body, wherein the mounting portion includes an intersecting direction facing portion that opposes the actuation portion in the axis intersecting direction between the first joint body and the actuation portion in the facing state of the axially facing portion and the protruding portion.

(3) The first joint according to (2), wherein the mounting portion is movable between a first position and a second position along the axial direction, the first position indicates a position at which the intersecting direction facing portion opposes the actuation portion in the axis intersecting direction, and the second position indicates a position at which the intersecting direction facing portion is separated from the first position in the axial direction.

(4) The first joint according to (3), wherein the first joint body includes a first restricting portion to restrict movement of the intersecting direction facing portion between the first position and the second position.

(5) The first joint according to (4), wherein the first restricting portion includes a first recess recessed inward in a radial direction with respect to the central axis, and a convex portion that is connected to the first recess and protrudes outward in the radial direction, and the convex portion is located farther from the actuation portion in the axial direction than the first recess.

(6) The first joint according to (5), wherein the first restricting portion further includes a second recess recessed inward in the radial direction, the second recess is connected to the convex portion and is located farther from the actuation portion in the axial direction than the convex portion, the first joint body further includes an overhanging portion that is connected to the second recess in the axial direction and is located farther from the actuation portion in the axial direction than the second recess, and a maximum outer diameter of the overhanging portion is equal to or larger than a maximum outer diameter of the convex portion.

(7) The first joint according to any one of (2) to (6), wherein the mounting portion includes a curved portion curved along a circumferential direction with respect to the central axis, and an opening, and the curved portion is fitted to the outer peripheral surface of the first joint body.

(8) The first joint according to (7), wherein an angle defined between one end and another end of the curved portion in the circumferential direction with respect to the central axis is about 230 degrees or more and about 250 degrees or less.

(9) The first joint according to (7) or (8), wherein the curved portion includes a first surface portion located at one end portion of the curved portion in the circumferential direction and extending along the axis intersecting direction, and a second surface portion located at another end portion of the curved portion in the circumferential direction and extending along the axis line intersecting direction, and the first surface portion and the second surface portion are parallel or substantially parallel to each other.

(10) The first joint according to any one of (3) to (9), wherein the mounting portion further includes a second restricting portion to restrict movement of the actuation portion in the circumferential direction with respect to the central axis, and the second restricting portion opposes both circumferential end surfaces of the actuation portion in the circumferential direction.

(11) The first joint according to (10), wherein in a state in which the mounting portion is located at the first position and in a state in which the mounting portion is located at the second position, the second restricting portion opposes both of the circumferential end surfaces of the actuation portion in the circumferential direction.

(12) The first joint according to any one of (2) to (11), wherein the mounting portion includes a pair of inclined surfaces inclined with respect to the central axis, and the pair of inclined surfaces extends with respect to the central axis from the front end toward a rear end of the first joint body.

(13) The first joint according to any one of (2) to (12), wherein the mounting portion includes a pair of planes intersecting with the axial direction.

(14) The first joint according to any one of (2) to (13), further including an elastic portion extending along the axis intersecting direction and having elasticity, wherein the mounting portion further includes a third recess recessed in the axial direction, and the elastic portion overlaps the third recess in the axis intersecting direction and supports the actuation portion in the axis intersecting direction.

(15) The first joint according to (2), wherein the mounting portion is rotatable between a first position and a second position along a circumferential direction with respect to the central axis, the first position indicates a position at which the intersecting direction facing portion faces the actuation portion in the axis intersecting direction, and the second position indicates a position at which the intersecting direction facing portion is separated from the first position in the circumferential direction.

(16) A pipe joint including the first joint according to any one of (2) to (15), and the second joint.

(17) The first joint according to (1), wherein the actuation portion has a hole extending along the axial direction, and the mounting portion includes, as the actuation portion restricting portion, a mounting portion protruding portion disposed in the hole in the facing state of the axially facing portion and the protruding portion.

(18) The first joint according to (1), wherein the mounting portion includes, as the actuation portion restricting portion, a cover portion disposed radially outside a radially outer surface of the actuation portion in the facing state of the axially facing portion and the protruding portion.

(19) The first joint according to (18), wherein the mounting portion is movable between a first position and a second position along the axial direction, the first position indicates a position at which the cover portion opposes the actuation portion in the axis intersecting direction, the second position indicates a position at which the cover portion is separated from the first position in the axial direction, and at the first position, a radially inner surface of the cover portion and a radially outer surface of the actuation portion face each other with a space.

(20) The first joint according to (18) or (19), wherein the mounting portion further includes a movement restricting portion to restrict movement of the mounting portion in a circumferential direction with respect to the central axis, the actuation portion is located radially outside a radially outer surface of the first joint body in the facing state of the axially facing portion and the protruding portion, and the movement restricting portion faces both end surfaces in the circumferential direction of the actuation portion in the circumferential direction in the facing state of the axially facing portion and the protruding portion.

(21) A pipe joint including the first joint according to (1) or any one of (17) to (20), and the second joint.

Example embodiments of the present disclosure can be applied to, for example, first joints and pipe joints.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A first joint having a central axis and extending in an axial direction along the central axis, the first joint comprising:
a first joint body to be coupled to a second joint along the central axis;
an axially facing portion that opposes a protruding portion protruding from an outer peripheral surface of the second joint in the axial direction from a front end side in the axial direction of the first joint body in a state in which the first joint body is coupled to the second joint;
an actuation portion that is connected to the axially facing portion and is actuated along an axis intersecting direction intersecting the central axis to switch between a facing state and a non-facing state of the axially facing portion and the protruding portion in the axial direction; and
a mounting portion to be mounted on an outer peripheral surface of the first joint body; wherein
the mounting portion includes an actuation portion restricting portion to restrict movement of the actuation portion in the facing state of the axially facing portion and the protruding portion.

2. A first joint having a central axis and extending in an axial direction along the central axis, the first joint comprising:
a first joint body to be coupled to a second joint along the central axis;
an axially facing portion that opposes a protruding portion protruding from an outer peripheral surface of the second joint in the axial direction from a front end side in the axial direction of the first joint body in a state in which the first joint body is coupled to the second joint;
an actuation portion that is connected to the axially facing portion and is actuated along an axis intersecting direction intersecting the central axis to switch between a facing state and a non-facing state of the axially facing portion and the protruding portion in the axial direction; and
a mounting portion to be mounted on an outer peripheral surface of the first joint body; wherein
the mounting portion includes an intersecting direction facing portion that opposes the actuation portion in the axis intersecting direction between the first joint body and the actuation portion in the facing state of the axially facing portion and the protruding portion.

3. The first joint according to claim 2, wherein
the mounting portion is movable between a first position and a second position along the axial direction;
the first position indicates a position at which the intersecting direction facing portion opposes the actuation portion in the axis intersecting direction; and
the second position indicates a position at which the intersecting direction facing portion is separated from the first position in the axial direction.

4. The first joint according to claim 3, wherein the first joint body includes a first restricting portion to restrict movement of the intersecting direction facing portion between the first position and the second position.

5. The first joint according to claim 4, wherein
the first restricting portion includes:
a first recess recessed inward in a radial direction with respect to the central axis; and
a convex portion that is connected to the first recess and protrudes outward in the radial direction; and
the convex portion is located farther from the actuation portion in the axial direction than the first recess.

6. The first joint according to claim 5, wherein
the first restricting portion further includes a second recess recessed inward in the radial direction;
the second recess is connected to the convex portion and is located farther from the actuation portion in the axial direction than the convex portion;
the first joint body further includes an overhanging portion that is connected to the second recess in the axial direction and is located farther from the actuation portion in the axial direction than the second recess; and
a maximum outer diameter of the overhanging portion is equal to or larger than a maximum outer diameter of the convex portion.

7. The first joint according to claim 2, wherein
the mounting portion includes:
a curved portion curved along a circumferential direction with respect to the central axis; and
an opening; and
the curved portion is fitted to the outer peripheral surface of the first joint body.

8. The first joint according to claim 7, wherein an angle defined between one end and another end of the curved portion in the circumferential direction with respect to the central axis is about 230 degrees or more and about 250 degrees or less.

9. The first joint according to claim 7, wherein
the curved portion includes:
a first surface portion located at one end portion of the curved portion in the circumferential direction and extending along the axis intersecting direction; and
a second surface portion located at another end portion of the curved portion in the circumferential direction and extending along the axis line intersecting direction; and
the first surface portion and the second surface portion are parallel or substantially parallel to each other.

10. The first joint according to claim 3, wherein
the mounting portion further includes a second restricting portion to restrict movement of the actuation portion in the circumferential direction with respect to the central axis; and
the second restricting portion opposes both circumferential end surfaces of the actuation portion in the circumferential direction.

11. The first joint according to claim 10, wherein in a state in which the mounting portion is located at the first position and in a state in which the mounting portion is located at the second position, the second restricting portion opposes both of the circumferential end surfaces of the actuation portion in the circumferential direction.

12. The first joint according to claim 2, wherein
the mounting portion includes a pair of inclined surfaces inclined with respect to the central axis; and
the pair of inclined surfaces extends with respect to the central axis from the front end toward a rear end of the first joint body.

13. The first joint according to claim 2, wherein the mounting portion includes a pair of planes intersecting with the axial direction.

14. The first joint according to claim 2, further comprising:
an elastic portion extending along the axis intersecting direction and having elasticity; wherein
the mounting portion further includes a third recess recessed in the axial direction; and
the elastic portion overlaps the third recess in the axis intersecting direction and supports the actuation portion in the axis intersecting direction.

15. The first joint according to claim 2, wherein
the mounting portion is rotatable between a first position and a second position along a circumferential direction with respect to the central axis;
the first position indicates a position at which the intersecting direction facing portion opposes the actuation portion in the axis intersecting direction; and
the second position indicates a position at which the intersecting direction facing portion is separated from the first position in the circumferential direction.

16. A pipe joint comprising:
the first joint according to claim 2; and
the second joint.

17. The first joint according to claim 1, wherein
the actuation portion includes a hole extending along the axial direction; and
the mounting portion includes, as the actuation portion restricting portion, a mounting portion protruding portion in the hole in the facing state of the axially facing portion and the protruding portion.

18. The first joint according to claim 1, wherein the mounting portion includes, as the actuation portion restricting portion, a cover portion radially outside a radially outer surface of the actuation portion in the facing state of the axially facing portion and the protruding portion.

19. The first joint according to claim 18, wherein
the mounting portion is movable between a first position and a second position along the axial direction;
the first position indicates a position at which the cover portion opposes the actuation portion in the axis intersecting direction;
the second position indicates a position at which the cover portion is separated from the first position in the axial direction; and
at the first position, a radially inner surface of the cover portion and a radially outer surface of the actuation portion face each other with a space.

20. The first joint according to claim 18, wherein
the mounting portion further includes a movement restricting portion to restrict movement of the mounting portion in a circumferential direction with respect to the central axis;
the actuation portion is located radially outside a radially outer surface of the first joint body in the facing state of the axially facing portion and the protruding portion; and
the movement restricting portion opposes both end surfaces in the circumferential direction of the actuation portion in the circumferential direction in the facing state of the axially facing portion and the protruding portion.
